(19) United States
(12) Patent Application Publication
(10) Pub. No.: US 2020/0270533 A1
(43) Pub. Date: Aug. 27, 2020

(54) HYDROPROCESSING FEEDSTOCKS HAVING SILICON CONTENT

(71) Applicant: ExxonMobil Research and Engineering Company, Annandale, NJ (US)

(72) Inventors: Xiaochun Xu, Basking Ridge, NJ (US); Gregory J. De Martin, Flemington, NJ (US); Keith Wilson, Weybridge, Surrey (GB); Doron Levin, Highland Park, NJ (US); Stuart L. Soled, Pittstown, NJ (US); Sabato Miseo, Pittstown, NJ (US)

(21) Appl. No.: 16/783,598

(22) Filed: Feb. 6, 2020

Related U.S. Application Data
(60) Provisional application No. 62/808,942, filed on Feb. 22, 2019.

(51) Int. Cl. C10G 45/08; B01J 23/00; B01J 37/20

(52) U.S. Cl. CPC C10G 45/08; B01J 23/002; B01J 37/20; C10G 2300/4012; C10G 2300/202; C10G 2300/1037; C10G 2300/4006; C10G 2300/4018

(57) ABSTRACT

The present disclosure provides processes for hydroprocessing hydrocarbon feedstocks comprising a silicon content of about 1 wppm or greater. In at least one embodiment, a process includes introducing, in a reactor or to the reactor, a hydrocarbon feedstock having a silicon content of at least about 1 wppm, based on the total weight of the hydrocarbon feedstock, to a treat gas to produce a hydrocarbon feedstock/treat gas mixture. The process includes introducing the hydrocarbon feedstock/treat gas mixture to a catalyst composition comprising at least one group 6 metal and at least one group 8-10 metal, wherein the molar ratio of group 6 metal to group 8-10 metal is from about 10:1 to about 1:10. The process includes obtaining a liquid product comprising a sulfur content of 5,000 wppm or less. Furthermore, processes of the present disclosure provide hydroprocessing of high Si content feeds using hydrocarbon feeds at high liquid hourly space velocities.

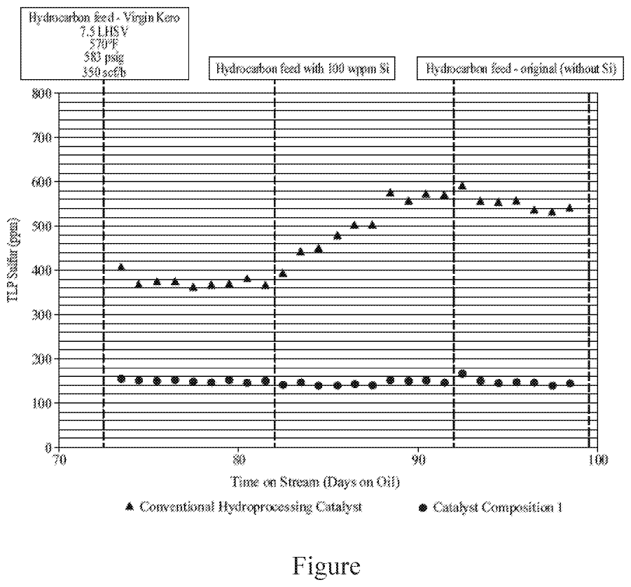

### CROSS-REFERENCE TO RELATED APPLICATIONS

This Application claims priority to U.S. Provisional Application No. 62/808,942 filed Feb. 22, 2019, which is herein incorporated by reference in its entirety.

### FIELD

The present disclosure provides processes for hydroprocessing hydrocarbon feedstocks having a silicon content.

### BACKGROUND

Refiners are facing multiple challenges from constant new regulations on sulfur levels in hydrocarbon feedstocks (e.g., gasoline and diesel fuel), the rising cost of crudes and other raw materials, and directives to decrease the cost of production in order to improve profitability. As refineries increase demand to process crudes with larger amounts of sulfur and nitrogen, while at the same time environmental regulations are mandating lower levels of these heteroatoms in products, a need exists to synthesize catalysts that can do more efficient desulfurization and denitrogenation, particularly where existing units are limited in their pressure capability. In addition, more refractory feeds are desirable from a cost perspective. Since residual sulfur- and/or nitrogen-containing molecules can poison metal or acid sites on catalysts used downstream of the hydrotreating process (such as in hydrocrackers), improvements in the hydroprocessing feed pretreatment (e.g., to FCC and/or hydrocracking units) can have a large impact on how acid and/or metal catalysts operate. Alumina-supported Ni or Ni/Co-promoted molybdenum sulfides are the traditional catalysts used for hydrodenitrogenation (HDN) or hydrodesulfurization (HDS) at intermediate and relatively high pressures, and alumina-supported Co-promoted molybdenum sulfides are the traditional catalysts for HDS at relatively low pressures.

In addition, many of hydrocarbon feeds coming into the refinery may contain unknown levels of common catalyst poisons such as silicon. Various contaminants (e.g., organic silicon compounds) are poisons to the hydroprocessing catalysts and reforming catalysts, commonly leading to pressure drop build up or unexpected catalyst deactivation, which can both result in shortened cycle length of hydrotreaters and unexpected turnarounds. In particular, silicon contamination is an issue in refinery units (e.g., treating coker naphtha). In these units, the rate of silicon deposition on the catalyst is usually what determines run length. A very important parameter for the cycle length of a hydroprocessing unit is the deactivation rate of the installed hydroprocessing catalyst.

Generally, organic silicon compounds are typically not indigenous to the feed and are added during the oil production process or refining process. In recent years, with the increased processing of tight oil and heavy crudes, refineries have seen an increased silicon content in feeds used for hydroprocesses. For example, silicon found in oil fractions originates from Si-containing anti-foam additives used in coker units, as well as from the use of chemicals introduced during oil transport and tertiary oil recovery. Since silicon is a poison to hydroprocessing catalysts, many hydroprocessing units typically shut down and replace the catalyst which interrupts commercial productivity. In extreme cases of contamination, cycle lengths can be as short as three to six months. Furthermore, in order to control (e.g., slow down) the catalysts' contamination by silicon, conventional hydroprocesses are performed by introducing feeds to a hydroprocessor at a low liquid hourly space velocity (also referred to as “LHSV”) (e.g., LHSV of about 2.5 h⁻¹ or less), thus restricting the production of high quality fuels.

To overcome the challenges of achieving performant hydroprocessing of hydrocarbon feedstocks despite the presence of the silicon contaminants, high surface area guard catalysts designed for maximum silicon capacity, also referred to as silica guard catalysts, were developed. The silica guard catalysts are commonly used along the active HDS and HDN catalysts, for example, in order to trap silicon contaminants even though the silica guard catalysts do not have hydroprocessing catalytic activity. Silicon trapping materials are often used in order to maintain or increase the cycle length of the naphtha treaters, for example. However, the use of contaminant-trapping catalysts is costly and further requires removal of the spent guard catalysts. Furthermore, loading contaminant-trapping catalysts reduces the available volume for active hydroprocessing catalysts.

Therefore, there is a need for improved processes for processing hydrocarbon feedstocks, such as processes for hydroprocessing hydrocarbon feedstocks having high silicon content. For example, there is a need for upgraded processes for processing hydrocarbon feedstocks having high silicon content that can be introduced to a reactor at a high LHSV, thus using catalysts with high catalyst activity and high catalyst stability during the process.

References for citing in an Information Disclosure Statement (37 C.F.R. 1.97(h)): U.S. Pat. No. 7,288,182 B1; U.S. Pub. No. 2018/0264450 Al, Olsen, C , Lansdown, M., Rosinski, G., Slemp, B., Wade, R., Watkins, B., Catalagram® A Catalysts Technologies Publication, Advanced Refining Technologies®, issue 2012, No. 112; Siegel, J., Olsen, C., “Feed Contaminants in Hydroprocessing Units”, Advanced Refining Technologies, ART Catalagram® 104 Special Edition, Fall 2008, Chicago (IL, USA); D'Angelo, G., “StART® Catalyst System Success Story”, Advanced Refining Technologies Catalagram®, Special Edition Issue No. 110/2011; Olsen, C., “AT734G: A Combined Silicon and Arsenic Guard Catalyst”, Advanced Refining Technologies Catalagram®, issue No. 108 Special Edition, 2010.

### SUMMARY

The present disclosure provides processes for hydroprocessing hydrocarbon feedstocks having a silicon content.

In at least one embodiment, a process includes introducing, in a reactor or to the reactor, a hydrocarbon feedstock having a silicon content of at least about 1 wppm, based on the total weight of the hydrocarbon feedstock, to a treat gas to produce a hydrocarbon feedstock/treat gas mixture. The process includes introducing the hydrocarbon feedstock/treat gas mixture to a catalyst composition comprising at least one group 6 metal and at least one group 8-10 metal, and wherein the molar ratio of group 6 metal to group 8-10 metal is from about 10:1 to about 1:10. The process includes obtaining a liquid product comprising a total liquid product sulfur content of 5,000 wppm or less.

### BRIEF DESCRIPTION OF THE DRAWING

The FIGURE is a graph illustrating the catalyst activities for hydroprocessing a hydrocarbon feed using a conventional hydroprocessing catalyst or a catalyst compound of the present disclosure, according to one embodiment.

### DETAILED DESCRIPTION

The present disclosure provides processes for hydroprocessing hydrocarbon feedstocks having a silicon content of about 1 wppm or greater. In at least one embodiment, a process includes introducing a hydrocarbon feedstock having a silicon (Si) content of at least about 1 wppm (e.g., silicon content of from about 1 wppm to about 150 wppm), based on the total weight of the hydrocarbon feedstock. The process can include introducing a treat gas (e.g., hydrogen) to the hydrocarbon feedstock to produce a hydrocarbon feedstock/treat gas mixture. The process can include introducing the hydrocarbon feedstock/treat gas mixture to a catalyst composition including at least one group 6 metal and at least one group 8-10 metal, and wherein the ratio of group 6 metal to group 8-10 metal is from about 10:1 to about 1:10, in one or more hydroprocessing reactors (e.g., fixed bed reactor, slurry bed reactor, ebullating bed reactor, or batch high-pressure reactor). The process can include obtaining a liquid product (e.g., a fuel composition product) including a total liquid product (TLP) sulfur (S) content of about 5,000 wppm or less, such as a liquid product having a reduced content or removal of sulfur, nitrogen, oxygen, metals, or other contaminations as compared to the hydrocarbon feedstock, while maintaining a catalyst composition with high catalyst activity for the hydrocarbon feedstock conversion (e.g., a catalyst composition highly resistant to Si poisoning with little to no Si deposited on the catalyst composition).

In at least one embodiment, the catalyst composition including at least one group 6 metal and at least one group 8-10 metal is a bulk mixed catalyst composition. The bulk mixed catalyst compositions of the present disclosure can be used in a hydroprocessing process (e.g., hydrodemetallation, hydrodewaxing, hydrotreating, hydrogenation, hydrodesulfurization, hydrodenitrogenation, hydrodearomatization, hydroisomerization, and hydrocracking (including selective hydrocracking), or combinations thereof), to treat one or more feeds under wide-ranging reaction conditions, such as temperatures from about 200° C. to about 450° C., hydrogen pressures from about 72.52 psig to about 4351.1 psig (about 0.5 MPag to about 30 MPag), LHSVs from about 0.05 h⁻¹ to about 100 h⁻¹ (such as from about 0.05 h⁻¹ to about 25 h⁻¹), and/or hydrogen treat gas rates from about 200 scf/b to about 10,000 scf/b, which may maintain high catalyst activity. A hydrocarbon feedstock may contain a sulfur content of about 50 wppm or greater, and/or a nitrogen content of at least 1 wppm or greater. Moreover, a hydrocarbon feedstock may contain a Si content of from about 1 wppm to about 5,000 wppm, such as about 1 wppm to about 1,000 wppm, such as about 1 wppm to about 200 wppm, such as about 1 wppm to about 150 wppm, and/or little to no Si deposited on the catalyst composition. Processes of the present disclosure can be carried out at a time on stream of from several months up to about 10 years at an LHSV of 15 h⁻¹, for example. For time on stream, as used herein, “at an LHSV of 15 h⁻¹” is used only as a reference point to properly quantify the time on stream and does not require a method to be performed at 15 h⁻¹.

All numerical values within the detailed description and the claims herein are modified by “about” or “approximately” the indicated value, and take into account experimental error and variations that would be expected by a person of ordinary skill in the art.

For purposes herein, the numbering scheme for the Periodic Table Groups is used as described in CHEMICAL AND ENGINEERING NEWS, 63(5), pg. 27 (1985). For example, a “group 6 metal” is an element from group 6 of the Periodic Table, e.g., Cr, Mo, W or Sg.

The following abbreviations may be used herein: RT is room temperature (and is 23° C. unless otherwise indicated), TLP is total liquid product, HDS is hydrodesulfurization, HDN is hydrodenitrogenation, TOS is time on stream, wppm is weight parts per million, DMDS is dimethyldisulfide, Nm³ is normal cubic meter, Mpag is megapascal gauge, scf/b is standard cubic feet per barrel, wt % is weight percent, cP is centipoise, BN is bromine number, NMR is nuclear magnetic resonance, TGR is treat gas rate, LHSV is liquid hourly space velocity, WHSV is weight hourly space velocity, o- is ortho-, p- is para-, m-is meta-, GC-MS is gas chromatograph mass spectrometer, SIMDIS GC is Simulated Distillation Gas Chromatography, TEM is transmission electron microscopy, EDX is energy dispersive X-ray.

“Catalyst activity” is a measure of how active the catalyst is and is reported as the total liquid product (wppm) of certain components, such as sulfur or nitrogen present in a fuel composition product, also referred to as the liquid product, after a conversion process of a hydrocarbon feedstock (e.g., hydroprocessing of a hydrocarbon feedstock, such as HDS). For example, when the conversion process of the hydrocarbon feedstock is an HDS process, the terms “high catalyst activity” mean that a catalyst or catalyst composition can convert a hydrocarbon feedstock to a fuel composition product (e.g., a liquid product) including a sulfur content lower than that of a fuel composition product (e.g., a liquid product) formed from a catalyst or catalyst composition exhibiting lower catalyst activity. Hence, when a catalyst or a catalyst composition is contaminated by Si contaminants (e.g., Si content of at least about 1 wppm in the hydrocarbon feedstock), the TLP sulfur increases, indicating that the Si deposition on the catalyst, or catalyst composition, induces the deactivation of the catalyst or catalyst composition.

Catalyst activity as a function of the time on stream (e.g., days on oil) at a high LHSV value (e.g., LHSV value of about 5 h⁻¹ or greater, such as about 15 h⁻¹ or greater, such as about 30 h⁻¹ or greater, such as about 60h⁻¹ or greater, such as about 90 h⁻¹ or greater) is referred to as “catalyst stability”.

The term “bulk”, used in the specification when describing a mixed metal oxide catalyst composition, indicates that the catalyst composition is self-supporting in that it does not require a carrier or support.

The term “hydroprocessing,” as used herein, should be understood to encompass all suitable processes in which a hydrocarbon feedstock is reacted with hydrogen (e.g., at the temperatures and pressures noted above), and can include hydrodemetallation, hydrodewaxing, hydrotreating, hydrogenation, hydrodesulfurization, hydrodenitrogenation, hydrodearomatization, hydroisomerization, and hydrocracking (including selective hydrocracking), and combinations thereof. Depending on the type of hydroprocessing and the reaction conditions, the products of the hydroprocessing process may show improved viscosities, viscosity indices, saturate contents, low temperature properties, volatilities, depolarization, or combinations thereof, as compared to products of hydroprocessing process obtained by using conventional hydroprocessing catalysts. It should be understood that hydroprocessing can be practiced in one or more reaction zones, in either countercurrent flow or co-current flow mode. By countercurrent flow mode is meant a process mode in which the feedstream flows in a direction opposite to the flow of hydrogen-containing treat gas. The hydroprocessing reactor can also be operated in any suitable catalyst-bed arrangement mode (e.g., fixed bed, slurry bed, ebullating bed), in series or in parallel, or in a combination thereof.

The terms “liquid hourly space velocity”, also referred to as “LHSV” means the volumetric rate of a feed mixture (e.g., a liquid feed) divided by the volume of a catalyst, and is given in hr⁻¹.

The “Bromine number” (BN) is the amount of bromine in grams absorbed by 100 grams (3.5 oz) of a sample. The bromine number indicates the degree of unsaturation (e.g., measure of aliphatic unsaturation in gasoline samples), and is a good indicator of total olefins content regardless whether the olefins are reactive or not.

### Feeds

A wide range of hydrocarbon feedstocks can be hydroprocessed in accordance with the present disclosure. Suitable feedstocks may include whole petroleum crudes, reduced petroleum crudes, atmospheric residua, vacuum residua, asphaltenes, deasphalted oils (e.g., brightstock), cycle oils, fluid catalytic cracking (FCC) tower bottoms, gas oils (including atmospheric and vacuum gas oils, as well as coker gas oils), light to heavy distillates (including raw virgin distillates), hydrocrackates, hydrotreated oils, dewaxed oils, slack waxes, Fischer-Tropsch waxes, raffinates, naphthas, and combinations thereof. The hydrocarbon feedstock can be a petroleum fraction feedstock (e.g., gasoline, diesel), for example derived from upgrading petroleum, including a gas oil (GO) feedstock, a light gas oil (LGO), a vacuum gas oil (VGO) feedstock, a heavy gas oil (HGO) feedstock, a middle distillate feedstock (e.g., kerosene, jet fuels, diesel oils), a heavy-middle distillate feedstock, or combinations thereof. The hydrocarbon feedstock can be virgin or straight run oils which contain aromatics and which have not been previously dealkylated (dealkylation of large C₅ -C₉ alkyl groups) by processes such as catalytic cracking or coking. For example, the hydrocarbon feedstock can be virgin mid-distillates, such as virgin kerosene. Virgin kerosene can be upgraded to jet fuel, for example. The hydrocarbon feedstock may include heavy hydrocarbons. Heavy hydrocarbons can have a high boiling point, high viscosity, and/or high density relative to lighter refinery streams such as middle distillates and VGO. One example of a heavy hydrocarbon feed can be a clarified slurry oil (CSO), which is produced in an oil refinery as the bottoms fraction of an FCC unit. The hydrocarbon feedstock may be mixed/combined/blended with any suitable utility fluids, for instance, when dilution is needed to reduce the viscosity of the feedstock.

The hydrocarbon feedstock may include biofuels, liquid fuels which can be made from biomass, also known as second generation, or advanced biofuels. Biomass sources include wood wastes, energy crops, aquatic plants, agricultural crops, and their waste products, as well as municipal and animal wastes. Biomass sources are considered to be potential sources of fuels and chemical feedstocks. The hydrocarbon feedstock may also include “renewable fuel oil” (also referred to as “RFO”). The term “renewable fuel oil” refers to a biomass-derived fuel oil or a fuel oil produced from the conversion of biomass. So long as there is sufficient sulfur content in the feedstock to implicate the use of hydroprocessing catalysts, suitable RFO examples can be: i) a cellulosic renewable fuel oil (also referred to as “cellulosic RFO”), and may be derived or prepared from the conversion of cellulosic-containing biomass; ii) a renewable or biofeed in the form of lipid material in addition to hydrocarbons. The term “lipid material,” as used herein, is a composition comprised of biological materials. Examples of biological materials may include vegetable fats/oils, animal fats/oils, fish oils, pyrolysis oils, algae lipids/oils, as well as components of such materials, or mixture thereof. Furthermore, the lipid material may include one or more type of lipid compounds. Lipid compounds can be biological compounds that are insoluble in water, but soluble in nonpolar (or fat) solvents such as alcohols, ethers, chloroform, alkyl acetates, benzene, and combinations thereof. Illustrative, but not limiting, examples of biofeeds which may be treated with the catalyst compositions of the present disclosure, either alone or in combinations with mineral oils, can be the biofeeds described in U.S. Pat. No. 8,722,564, which is fully incorporated herein by reference.

Prior to introduction to a processing reactor including the catalyst composition, the hydrocarbon feedstock may be mixed/combined/blended with a treat gas (e.g., treat gas including hydrogen), thus forming a hydrocarbon feedstock/treat gas mixture, also referred to as a feed. The hydrocarbon feedstock and treat gas can be mixed/combined/blended at a molar ratio of hydrocarbon feedstock: treat gas of about 10 scf/b to about 20,000 scf/b, such as from about 100 scf/b to about 5,000 scf/b; at a temperature of from about 23° C. (73.4° F.) to about 482.2° C. (900° F.); a pressure of from about atmospheric pressure to about 5,000 psig. In at least one embodiment, the treat gas is hydrogen.

A treat gas can be either pure hydrogen or a hydrogen containing gas, which is a gas stream including hydrogen in an amount that is sufficient for the intended reaction(s), and may optionally include one or more other gasses (e.g., nitrogen and light hydrocarbons such as methane), and which will not adversely interfere with or affect either the reactions or the products. Impurities, such as H₂S and NH₃, can be removed from the treat gas before it is conducted to the reactor. The treat gas stream introduced into a reaction process may contain at least about 50 vol % hydrogen, such as at least about 75 vol % hydrogen, based on the total volume of the treat gas.

The hydrocarbon feedstocks may have a nitrogen content of at least 1 wppm nitrogen, such as from about 10 wppm nitrogen to about 500 wppm, such as from about 20 wppm nitrogen to about 400 wppm nitrogen, such as from about 100 wppm nitrogen to about 300 wppm nitrogen, alternatively from about 500 wppm nitrogen to about 5,000 wppm nitrogen, such as from about 600 wppm nitrogen to about 800 wppm nitrogen, thus in the form of organic nitrogen compounds.

The hydrocarbon feedstocks may have a sulfur content of from about 0.01 wt % to about 10 wt %, such as from about 0.15 wt % to about 5 wt %, such as from about 0.2 wt % to about 3 wt %, such as from about 0.3 wt % to about 1 wt %. The hydrocarbon feedstock can be treated in any suitable manner to reduce the sulfur and/or nitrogen content thereof (e.g., hydrodesulfurization, hydrodenitrogenation).

The hydrocarbon feedstocks can have a density of from about 0.6 g/cm³ to about 1.1 g/cm³, such as from about 0.5 g/cm³ to about 1 g/cm³, such as from about 0.4 g/cm³ to about 0.8 g/cm³.

The hydrocarbon feedstocks may have an end boiling point, which can be measured according to ASTM D2887, of from about 37.8° C. (100° F.) to about 900° C. (1,652° F.), such as from about 65.5° C. (150° F.) to about 700° C. (1,292° F.), such as from about 90° C. (194° F.) to about 500° C. (932° F.), as determined by distillation or Simulated Distillation Gas Chromatography (SIMDIS GC) analysis. The boiling range distribution of hydrocarbon feedstock fractions (e.g., petroleum fractions) can be determined by Gas Chromatography analysis, such as a Simulated Distillation Gas Chromatography (SIMDIS GC) analysis. For example, the boiling point distribution at which a hydrocarbon feedstock fraction may distill (e.g., of from about 0.5% of hydrocarbon feedstock fraction that may distill to about 99.5% of hydrocarbon feedstock fraction that may distilled) is from about 37.8° C. (100° F.) to about 900° C. (1,652° F.), such as from about 65.5° C. (150° F.) to about 700° C. (1,292° F.), such as from about 90° C. (194° F.) to about 500° C. (932° F.). In at least one embodiment, the temperature at which 10% of the hydrocarbon feedstock fraction may distill is of from about 149° C. (300° F.) to about 165.5° C. (330° F.), such as at 158.9° C. (318° F.), for example. In another embodiment, the temperature at which 90% of the hydrocarbon feedstock fraction may distill is of from about 276.6° C. (530° F.) to about 298.9° C. (570° F.), such as at 288.3° C. (551° F.), for example.

The hydrocarbon feedstocks may have a bromine number (BN, g Br₂/100 g of the hydrocarbon feedstock) of less than 80, such as a BN of from about 0.5 to about 80, such as from about 10 to about 70, such as from about 20 to about 60, such as from about 30 to about 50, alternatively from about 1 to about 25, such as from 1.2 to 10.

The hydrocarbon feedstocks may have a hydrogen content of from about 5 wt % to about 30 wt %, such as from about 5 wt % to about 25 wt %, such as from about 10 wt % to about 20 wt %, based on the total weight of the feed, as determined by ¹H-NMR.

The hydrocarbon feedstocks may have an Si content (ppm, by weight) of at least about 1 wppm, such as about 2 wppm or greater, such as about 10 wppm or greater, such as about 25 wppm or greater, such as about 50 wppm or greater, such as about 100 wppm or greater, such as from about 1 wppm to about 150 wppm, such as from about 5 wppm to about 100 wppm, such as from about 10 wppm to about 50 wppm, alternatively from about 1 wppm to about 10 wppm, such as from about 1 wppm to about 5 wppm, alternatively from about 100 wppm to about 300 wppm, based on the weight of the hydrocarbon feedstock.

### Catalyst Compositions

Catalyst compositions of the present disclosure can be used in the hydroprocessing processes to catalyze reaction of hydrogen with a hydrocarbon feedstock comprised of a Si content of at least about 1 wppm, such as a Si content of from about 1 wppm to about 150 wppm. In at least one embodiment, catalyst compositions of the present disclosure include at least one group 6 metal and at least one group 8-10 metal, and/or the catalyst compositions can be bulk mixed catalyst compositions.

The catalyst compositions may be used as HDS, HDN, or cracking catalysts to provide one or more of: i) reduction in unsaturation (both olefinic and aromatic carbon-carbon double bonds); ii) removal or reduction of sulfur; iii) removal or reduction of nitrogen; iv) removal or reduction of oxygen; v) removal or reduction of metals or other contaminations in the feedstock and cracking (reduction of molecular weight).

The catalyst compositions can be prepared using any suitable processes, such as processes described in U.S. Pat. No. 7,288,182 B1 and U.S. Pub. No. 2018/0264450 A1, which are incorporated by reference herein.

In at least one embodiment, the catalyst activity of the catalyst compositions is defined by the TLP sulfur content (wppm) of the liquid product during or after the treatment (e.g., hydroprocessing) of the hydrocarbon feedstock, as a function of the TOS of the process (time in which the catalyst composition is present in the hydrocarbon feedstock).

In at least one embodiment, the Si resistance of the catalyst compositions of the present disclosure can be evaluated by measuring the amount of Si (wt %) deposited on the catalyst composition, based on the total weight of the catalyst composition, or by measuring the TLP sulfur content (wppm) of the liquid product during or after hydroprocessing of the hydrocarbon feedstock, as a function of the time on stream of the process (time in which the catalyst composition is present in the reactor and the process is occurring).

In at least one embodiment, the catalyst compositions of the present disclosure have high catalyst activity, hence convert a hydrocarbon feedstock to a fuel composition product (e.g., a liquid product) including a sulfur content lower than that of a fuel composition product (e.g., a liquid product) formed from a catalyst or catalyst composition with lower catalyst activity. As non-limiting examples, “high catalyst activity” might be determined by the Si content of the hydrocarbon feedstock where a Si content of the hydrocarbon feedstock is at least 1 wppm, such as from about 1 wppm to about 150 wppm, at a time on stream of about 100 days or more, to form a fuel composition product having a sulfur content of about 5,000 wppm or less, such as about 1,000 wppm or less, such as about 200 wppm or less. In contrast, low catalyst activity might mean that at a Si content in the hydrocarbon feedstock of at least 1 wppm, such as from about 1 wppm to about 150 wppm, at a time on stream of about 100 days or more, the fuel composition product has a sulfur content of greater than 200 wppm, such as from about 300 wppm to about 800 wppm, alternatively a sulfur content of greater than 5,000 wppm.

In at least one embodiment, the catalyst compositions of the present disclosure maintain high catalyst activity at a TOS of at least 50 days or greater at an LHSV of 15 h⁻¹, such as at least 100 days or greater at an LHSV of 15 h⁻¹, such as 1 year or greater at an LHSV of 15 h⁻¹, such as 5 years or greater at an LHSV of 15 h⁻¹.

Accordingly, in at least one embodiment, the catalyst compositions of the present disclosure have high catalyst stability which is defined by high catalyst activity at a TOS of at least 50 days or greater, such as at least 100 days or greater, such as 1 year or greater, such as 5 years or greater, and at a high LHSV value (e.g., LHSV value of about 5 h⁻¹ or greater, such as about 15 h⁻¹ or greater, such as about 30 h⁻¹ or greater, such as about 60h⁻¹ or greater, such as about 90 h⁻¹ or greater).

In at least one embodiment, a hydroprocess includes introducing the hydrocarbon feedstock/treat gas mixture to the catalyst composition at a time on stream of about 100 days or greater at an LHSV of 15 h⁻¹, such as the time on stream is 5 years or greater at an LHSV of 15 h⁻¹.

For example, a catalyst composition of the present disclosure may maintain high catalyst activity (e.g., TLP sulfur content included in the fuel composition product that is less than the TLP sulfur content included in the hydrocarbon feedstock, at a Si content in the hydrocarbon feedstock of from about 1 wppm to about 150 wppm, at a time on stream of about 20 days or greater, such as about 100 days or greater, such as 1 year or greater, such as 5 years or greater, with little to no Si deposited on the catalyst composition).

Furthermore, at a high boiling point of the hydrocarbon feedstock (e.g., temperature of from about 37.8° C. (100° F.) to about 900° C. (1,652° F.), such as from about 65.5° C. (150° F.) to about 700° C. (1,292° F.), such as from about 90° C. (194° F.) to about 500° C. (932° F.)), the catalyst composition can maintain its high catalyst activity (e.g., total liquid product sulfur of about 5,000 wppm or less, such as about 1,000 wppm or less, such as about 200 wppm or less, at a Si content in the hydrocarbon feedstock of from about 1 wppm to about 150 wppm, at a time on stream of from about 50 days to about 150 days, such as about 100 days, with little to no Si deposited on the catalyst composition).

### Catalyst Composition (A)

In at least one embodiment, the present disclosure provides a process for hydroprocessing a hydrocarbon feedstock (e.g., a petroleum feedstock), which feedstock may contain both nitrogen and sulfur, which process comprises contacting the hydrocarbon feedstock with a bulk mixed catalyst composition comprised of at least one group 8-10 metal and at least two group 6 metals and wherein the ratio of group 6 metal to group 8-10 metal of the composition is from about 10:1 to about 1:10.

Suitable examples of group 8, 9, or 10 metals can be iron, ruthenium, osmium, cobalt, rhodium, iridium, nickel, palladium, or platinum. In at least one embodiment, X is a group 8 metal selected from Ni and Co and the group 6 metals are selected from Mo and W. In a further embodiment of the present disclosure, A is a group 6 metal that is Mo, B is a group 6 metal that is W, and the molar ratio of Mo to W is from about 9:1 to about 1:9.

In at least one embodiment, the bulk mixed catalyst composition is represented by formula (I):

(X)_{b}(Mo)_{c}(W)_{d}O_{z} (I)

wherein:
X is a group 8, 9, or 10 metal;
the molar ratio of b: (c+d) is from about 0.5/1 to about 3/1, such as about 0.75/1 to about 1.5/1, such as about 0.75/1 to about 1.25/1;
the molar ratio of c:d is from about 0.01/1 to about 0.1/1, alternatively from about 1/10 to about 10/1, such as about 1/3 to about 3/1, such as about 2/3 to about 3/2; and
z=[2b+6 (c+d)]/2.

In at least one embodiment, the bulk catalyst composition of Formula (I) or Formula (I) is substantially amorphous and has a unique X-ray diffraction pattern showing crystalline peaks at d=2.53 Angstroms and d=1.70 Angstroms.

In at least one embodiment, the bulk catalyst composition of Formula (I) or Formula (I) is a bulk multimetallic catalyst composition comprised of at least one group 8 metal and at least one group 6 metals, such as two group 6 metals and wherein the ratio of group 6 metal to group 8 metal is from about 10:1 to about 1:10. In at least one embodiment, the catalyst composition of Formula (I) is a bulk trimetallic catalyst composition comprised of one group 8 metal, such as Ni or Co, and the two group 6 metals are Mo and W. The molar ratio of Mo to W can be about 9:1 to about 1:9. Furthermore, the bulk trimetallic catalyst compositions used in the practice of the present disclosure can be represented by Formula (I) where: i) X is a group 8 metal; ii) the molar ratio of b: (c+d) is from 0.5/1 to about 3/1, such as about 0.75/1 to about 1.5/1, such as about 0.75/1 to about 1.25/1; iii) the molar ratio of c:d is about 0.01/1, such as about 0.1/1, such as about 1/10 to about 10/1, such as about 1/3 to about 3/1, such as substantially equimolar amounts of Mo and W, e.g., about 2/3 to about 3/2; and iv) z=[2b+6 (c+d)]/2.

The catalyst composition of Formula (I) (e.g., mixed metal oxide catalyst composition) is readily produced by the decomposition of a precursor represented by formula (II):

(NH₄)ₐ(X)_{b}(Mo)_{c}(W)_{d}O_{z} (II)
wherein:
X is a group 8, 9, or 10 metal;
a molar ratio of a:b is from about 0.01/1 to about 1:1, such as about 0 to about 1; and b, c, and d, are as defined above, and z=[a+2b+6 (c+d)]/2. The precursor has similar crystalline peaks at d=2.53 (not shown) and 1.70 Angstroms.

Decomposition of the precursor (NH₄)ₐ(X)_{b}(Mo)_{c}(W)_{d}O_{z} (II) may be effected at elevated temperatures, e.g., temperatures of at least about 300° C., such as from about 300° C. to about 450° C., in a suitable atmosphere, e.g., inerts such as nitrogen, argon, or steam, until decomposition is substantially complete, i.e., the ammonium is substantially completely driven off. Substantially complete decomposition can be readily established by thermogravimetric analysis (TGA), e.g., flattening of the weight change curve.

The catalyst compositions of Formula (I) used in the practice of the present disclosure can be prepared by any suitable means. One such means is a process wherein not all of the metals are in solution. For example, the contacting of one or more metal components in the presence of a protic liquid includes mixing the metal component and subsequently reacting the resulting mixture. At least one metal component can be added at least partly in the solid state during the mixing process and that the metal of at least one of the metal components which have been added at least partly in the solid state, can remain at least partly in the solid state during the mixing and reaction processes. Examples of suitable metals can be ammonium molybdate, nickel nitrate hexahydrate, or ammonium metatungstate.

Furthermore, during the mixing process either at least one metal component can be added at least partly in the solid state and at least one metal component can be added in the solute state, or all metal components can be added at least partly in the solid state, wherein at least one of the metals of the metal components which can be added at least partly in the solid state may remain at least partly in the solid state during the entire process of the solid route. A metal component can be added “in the solute state” means that the whole amount of the metal component can be added as a solution of such metal component in a protic liquid. A metal component can be added “at least partly in the solid state” means that at least part of the metal component can be added as solid metal component and, optionally another part of the metal component can be added as a solution of such metal component in a protic liquid. A suitable example can be a suspension of a metal component in a protic liquid in which the metal can be at least partly present as a solid, and optionally partly dissolved in the protic liquid.

In at least one embodiment, a bulk catalyst composition of Formula (I) with high catalytic activity (as defined above) is obtained when the metal components, which are at least partly in the solid state during contacting, are porous metal components. The total pore volume and pore size distribution of such metal components can be approximately the same as those of conventional hydrotreating catalysts. Hence, the pore volume of the metal components can be of from about 0.05 ml/g to about 5 ml/g, such as from about 0.1 ml/g to about 4 ml/g, such as from about 0.1 ml/g to about 3 ml/g, such as from about 0.1 ml/g to about 2 ml/g, as determined by nitrogen adsorption. Little to no pores with a diameter smaller than 1 nm are typically present in conventional hydrotreating catalysts. Further, conventional hydrotreating catalysts may have a surface area of at least 10 m²/g, such as at least 50 m²/g, such as at least 100 m²/g, determined via the Brunauer-Emmett-Teller (BET) method. For instance, when the metal component is nickel carbonate, nickel carbonate may have a total pore volume of about 0.19 ml/g to about 0.39 ml/g, such as from about 0.24 ml/g to about 0.35 ml/g, determined by nitrogen adsorption, and a surface area of from about 150 m²/g to about 400 m²/g, such as from about 200 m²/g to about 370 m²/g, as determined by the BET method. Furthermore, metal components of the catalyst compositions of the present disclosure can have a median particle diameter of at least 50 nm, such as from about 50 nm to about 5,000 μm, such as from about 100 nm to about 3,000 μm. Moreover, the median particle diameter can be of from about 0.1 μm to about 50 μm, such as from about 0.5 μm to about 50 μm. For instance, by choosing a metal component which is added at least partly in the solid state and which has a large median particle diameter, the other metal components will only react with the outer layer of the large metal component particle. In this case, so-called “core-shell” structured bulk catalyst particles can be obtained.

Suitable morphology and texture of the metal component can either be achieved by applying suitable preformed metal components or by preparing these metal components by the above-described precipitation under such conditions that a suitable morphology and texture can be obtained. A proper selection of appropriate precipitation conditions can be made by routine experimentation, as described in U.S. Pat. No. 7,288,182 B1 and U.S. Pub. No. 2018/0264450 A1, which are incorporated by reference herein.

As described above, in order to retain the morphology and texture of the metal components which can be added at least partly in the solid state, the metal of the metal component should at least partly remain in the solid state during the whole process of such solid route. The amount of solid metals during the process of the solid route should not become zero. The presence of solid metal including particles can be detected by visual inspection at least if the diameter of the solid particles in which the metals are comprised is larger than the wavelength of visible light. Methods such as quasi-elastic light scattering (QELS) or near forward scattering can also be used to ensure that in the process of the solid route, metals are in the solute state.

The protic liquid to be applied in the solid or solution route for preparing catalyst compositions of the present disclosure can be any suitable protic liquid. Examples of protic liquid may include water, carboxylic acids, and alcohols such as methanol or ethanol. In at least one embodiment, a protic liquid is water, such as mixtures of an alcohol and water, such as water is used as protic liquid in the solid route described above. Additionally, different protic liquids can be applied simultaneously in the solid route. For instance, a suspension of a metal component in ethanol can be added to an aqueous solution of another metal component.

The group 6 metal may include chromium, molybdenum, tungsten, or mixtures thereof. Suitable group 8 metals can be, e.g., iron, cobalt, nickel, or mixtures thereof. A combination of metal components comprising nickel, molybdenum and tungsten or nickel, cobalt, molybdenum and tungsten can be applied in the process of the solid route. If the protic liquid is water, suitable nickel components, which are at least partly in the solid state during contacting, may include water-insoluble nickel components such as nickel carbonate, nickel hydroxide, nickel phosphate, nickel phosphite, nickel formate, nickel sulfide, nickel molybdate, nickel tungstate, nickel oxide, nickel alloys such as nickel-molybdenum alloys, Raney nickel, or mixtures thereof. Suitable molybdenum components, which are at least partly in the solid state during contacting, may include water-insoluble molybdenum components such as molybdenum (di- and tri) oxide, molybdenum carbide, molybdenum nitride, aluminum molybdate, molybdic acid (e.g., H₂MoO₄), molybdenum sulfide, or mixtures thereof. Finally, suitable tungsten components, which are at least partly in the solid state during contacting, may include tungsten di- and trioxide, tungsten sulfide (e.g., WS₂ and WS₃), tungsten carbide, tungstic acid (e.g. H₂WO₄—H₂O, H₂W₄O₁₃.9H₂O), tungsten nitride, aluminum tungstate (also meta-, or polytungstate), or mixtures thereof. These components can be commercially available or can be prepared by precipitation, for example (e.g., nickel carbonate can be prepared from a nickel chloride, sulfate, or nitrate solution by adding an appropriate amount of sodium carbonate).

Metal components mainly including C, O, and/or H can be employed. In at least one embodiment, the metal component to be added at least partly in the solid state is nickel carbonate because when nickel carbonate is applied, CO₂ evolves and positively influences the pH of the reaction mixture. Further, due to the transformation of carbonate into CO₂, the carbonate does not end up in the wastewater.

Suitable examples of nickel components which can be added in the solute state can be water-soluble nickel components, such as nickel nitrate, nickel sulfate, nickel acetate, nickel chloride, or mixtures thereof. Suitable examples of molybdenum and tungsten components, which can be added in the solute state, can be water-soluble molybdenum and tungsten components such as alkali metal or ammonium molybdate (also peroxo-, di-, tri-, tetra-, hepta-, octa-, or tetradecamolybdate), such as Mo-P heteropolyanion compounds, Mo—Si heteropolyanion compounds, W—P heteropolyanion compounds, W—Si heteropolyanion compounds, Ni—Mo—W heteropolyanion compounds, Co—Mo—W heteropolyanion compounds, alkali metal or ammonium tungstates (also meta-, para-, hexa-, or polytungstate), or mixtures thereof.

Suitable combinations of metal components can be nickel carbonate, tungstic acid and molybdenum oxide. Another suitable combination can be nickel carbonate, ammonium dimolybdate and ammonium metatungstate. Further suitable combinations of metal components can be used. Nickel carbonate may include a certain amount of hydroxy-groups, such as the amount of hydroxy-groups present in the nickel carbonate can be high.

An alternative process of preparing the catalyst compositions of Formula (I) or Formula (II) of the present disclosure can be via using a process including reacting in a reaction mixture a group 8 metal component in solution and a group 6 metal component in solution in order to further obtain a precipitate. In at least one embodiment, as in the case of the solid route, one group 8 metal component is reacted with two group 6 metal components. The molar ratio of group 6 metals to group 8 metals applied in the process of the solution route can be the same as described for the solid route. Suitable group 6 and group 8 metal components can be, e.g., water-soluble nickel, molybdenum and tungsten components (as described above) for the solid route. Further, group 8 metal components can be, e.g., cobalt or iron components. Further, group 6 metal components can be, e.g., chromium components. The metal components can be added to the reaction mixture in solution, suspension or as such. If soluble salts are added as such, they may dissolve in the reaction mixture and subsequently be precipitated. Suitable group 6 metal salts which are soluble in water can be ammonium salts, such as ammonium dimolybdate, ammonium tri-, tetra- hepta-, octa-, and tetradeca- molybdate, ammonium para-, meta-, hexa-, and polytungstate, alkali metal salts, silicic acid salts of group 6 metals such as molybdic silicic acid, molybdic silicic tungstic acid, tungstic acid, metatungstic acid, pertungstic acid, heteropolyanion compounds of Mo—P, Mo—Si, W—P, and W—Si. The group 6 metal-containing compounds which are not in solution at the time of addition, but where solution is effected in the reaction mixture, can be used. Examples of such group 6 metal-containing can be metal compounds which contain crystal water that, upon temperature increase, may dissolve in their own metal water. Further, non-soluble metal salts may be added in suspension or as such, and solution is effected in the reaction mixture. Suitable non-soluble metals salts can be heteropolyanion compounds of Co—Mo—W (moderately soluble in cold water), heteropolyanion compounds of Ni—Mo—W (moderately soluble in cold water).

The reaction mixture can be reacted to obtain a precipitate. Precipitation can be effected by adding a group 8 metal salt solution at a temperature and pH at which the group 8 metal and the group 6 metal can precipitate, or by adding a compound which can complex the metals and release the metals for precipitation upon temperature increase or pH change. Alternatively, precipitation can be effected by adding a group 6 metal salt solution at a temperature and pH at which the group 8 metal and group 6 metal precipitate, changing the temperature, changing the pH, or lowering the amount of the solvent. In at least one embodiment, the precipitate obtained under the process conditions (e.g., catalyst composition (I) or (II)) described above appears to have high catalytic activity (e.g., total liquid product sulfur of about 5,000 wppm or less, such as about 1,000 wppm or less, such as about 200 wppm or less, at a Si content in the hydrocarbon feedstock of from about 1 wppm to about 150 wppm, at a time on stream of from about 50 days to about 150 days, such as about 100 days, and/or with little to no Si deposited on the catalyst composition).

In contrast to the conventional hydroprocessing catalysts, which include a carrier impregnated with group 8 metals and group 6 metals, said precipitate (e.g., catalyst composition (I)) can be used without a support. Unsupported catalyst compositions (I) can be referred to as bulk catalysts. Changing the pH can be done by adding a base or an acid to the reaction mixture, or adding compounds which can decompose upon temperature, increase into hydroxide ions or H⁺ ions that can respectively increase or decrease the pH. Examples of compounds that decompose upon temperature increase, and thereby increase or decrease the pH, can be urea, nitrites, ammonium cyanate, ammonium hydroxide, ammonium carbonate, or a mixture thereof.

In an illustrative process according to the solution route, solutions of ammonium salts of a group 6 metal and a solution of a group 8 metal nitrate can be made. Both solutions can be heated to a temperature of approximately 90° C. Ammonium hydroxide can be added to the group 6 metal solution. The group 8 metal solution can be added to the group 6 metal solution and direct precipitation of the group 6 and group 8 metal components can occur. Such process can also be conducted at lower temperature and/or decreased pressure or higher temperature and/or increased pressure.

In another illustrative process according to the solution route, a group 6 metal salt, a group 8 metal salt, and ammonium hydroxide can be mixed in solution together and heated so that ammonia can be driven off and the pH can be lowered to a pH at which precipitation can occur. For instance, when nickel, molybdenum, and tungsten components are applied, precipitation may occur at a pH below 7.

Independently from whether the solid or solution route is chosen, the resulting bulk catalyst composition (I) may include one or more bulk catalyst particles. If the amount of liquid of the bulk catalyst composition (I) is high enough that it cannot be directly subjected to a shaping step, a solid liquid separation can be performed before shaping. Optionally the bulk catalyst composition, either as such or after solid liquid separation, can be calcined before shaping. The median diameter of the bulk catalyst particles can be at least 50 nm, such as from about 50 nm to about 5,000 μm, such as from about 100 nm to about 3,000 μm. Alternatively, the median particle diameter can be of from about 0.1 μm to about 50 μm, such as from about 0.5 μm to about 50 μm.

The processes of the present disclosure for preparing the bulk catalyst compositions (e.g., Formula (I)) may further include a sulfidation process. Sulfidation can be carried out by contacting the catalyst composition of Formula (I) or (II) with a sulfur containing compound such as elementary sulfur, hydrogen sulfide or polysulfides. For example, the sulfidation can be carried out subsequently to the preparation of the bulk catalyst composition of Formula (I) but prior to the addition of a binder material, and/or subsequently to the addition of the binder material but prior to subjecting the catalyst composition of Formula (I) to spray drying and/or any alternative process, and/or subsequently to subjecting the composition to spray drying and/or any alternative process but prior to shaping, and/or subsequently to shaping the catalyst composition of Formula (I) or (II). In at least one embodiment, the sulfidation is not carried out prior to any process that reverts the obtained metal sulfides into their oxides. Such processes can be calcination, or spray drying, or any other high temperature treatment in the presence of oxygen. Consequently, if the catalyst composition of Formula (I) is subjected to spray drying and/or any alternative technique, the sulfidation can be carried out subsequent to the application of any of these processes.

Additionally to, or instead of, a sulfidation process, the bulk catalyst composition of Formula (I) may be prepared from at least one metal sulfide. If the solid route is applied, the bulk catalyst component can be prepared from nickel sulfide and/or molybdenum sulfide and/or tungsten sulfide.

If the catalyst composition is used in a fixed bed process, the sulfidation can be carried out subsequent to the shaping process and, if applied, subsequent to the last calcination process. In at least one embodiment, the sulfidation is carried out ex situ, i.e., the sulfidation is carried out in a separate reactor prior to loading the sulfided catalyst composition into the hydroprocessing unit. Furthermore, the catalyst composition can be both sulfided ex situ and in situ.

In at least one embodiment, the bulk catalyst particles are sintering-resistant. Thus the active surface area of the bulk catalyst particles is maintained during use. The molar ratio of group 6 to group 8 metals may range from 10:1 to 1:10, such as from 3:1 to 1:3. In the case of a core-shell structured particle, these ratios of course apply to the metals contained in the shell. If more than one group 6 metal is contained in the bulk catalyst particles, the ratio of the different group 6 metals is not critical. The same holds when more than one group 8 metal is applied. In the case where Mo and W are present as group 6 metals, the Mo:W ratio can be of 9:1 to 1:9. In at least one embodiment, the group 8 metal includes Ni and/or Co. Furthermore, the group 6 metal may include a combination of Mo and W. Combinations of Ni/Mo/W, and Co/Mo/W, and Ni/Co/Mo/W can be used. Such types of precipitates appear to be sinter-resistant. Thus, the active surface area of the precipitate is remained during use. Furthermore, in at least one embodiment, catalyst compositions of Formula (I) are sinter-resistant, such as catalyst compositions of Formula (I) are resistant to Si contaminations, e.g., little to no Si deposit on catalyst compositions of Formula (I) with a hydrocarbon feedstock including a Si content of at least about 1 wppm.

The metals can be present as oxidic compounds of the corresponding metals, or if the catalyst composition of Formula (I) has been sulfided, sulfidic compounds of the corresponding metals.

In at least one embodiment, the particles of the catalyst composition have a surface area of at least 50 m²/g, such as at least 100 m²/g, as measured using the BET method. The particles may include about 50 wt % to about 100 wt %, such as about 70 wt % to about 100 wt % of at least one group 8 metal and at least one group 6 metal, based on the total weight of the particles, calculated as metal oxides. The amount of group 6 and group 8 metals can easily be determined by VIB TEM-EDX.

In at least one embodiment, the pore size distribution of the particles of the catalyst composition is approximately the same as the one of conventional hydrotreating catalysts, such as these particles have a pore volume of from about 0.05 ml/g to about 5 ml/g, such as from about 0.1 ml/g to about 4 ml/g, such as from about 0.1 ml/g to about 3 ml/g, such as from about 0.1 ml/g to about 2 ml/g, as determined by nitrogen adsorption. Additionally or alternatively, little to no pores smaller than 1 nm may be present. Furthermore, such particles can have a median diameter of at least 50 nm, such as from about 50 nm to about 5,000 μm, such as from about 100 nm to about 3000 μm. The median particle diameter can be of from about 0.1 μm to about 50 μm, such as of from about 0.5 μm to about 50 μm.

The surface area of the catalyst composition can be at least 40 m²/g, such as at least 80 m²/g, such as at least 120 m²/g. The total pore volume of the catalyst composition can be at least 0.05 ml/g, such as at least 0.1 ml/g, as determined by water porosimetry. To obtain catalyst compositions with high mechanical strength, the catalyst composition of Formula (I) of the present disclosure may have a low macroporosity. Also as previously stated, the catalyst composition may further include other hydroprocessing catalysts, binders, or cracking components. The binder materials and cracking components of the conventional hydroprocessing catalyst may include binder materials and/or cracking components. Suitable conventional hydroprocessing catalysts can be hydrotreating catalysts. The hydrotreating catalysts can be in the spent, regenerated, or fresh state.

The group 8 metal containing compound and the group 6 metal-containing compound can be added in various ways, at various temperatures, at various pHs, in solution, in suspension, or as such, simultaneously or sequentially.

The precursor compound of Formula (II) can also be readily prepared by one of several methods, including a variation of the boiling decomposition method, as described in U.S. Pat. No. 7,288,182 B1, which is incorporated by reference herein, in which a W-containing compound can be added to the initial mixture of a Mo salt, a Ni salt, and ammonium hydroxide. Direct precipitation and pH controlled precipitation may also be used to prepare the precursor compound (II). In all cases, however, water soluble salts of Ni, Mo and W can be employed.

In at least one embodiment, the Mo salts and W salts are ammonium compounds, e.g., ammonium molybdate, ammonium metatungstate, while the Ni salt may be the nitrate or hydrated nitrates.

The decomposed precursor can be sulfided or pre-sulfided by any suitable sulfidation processes. For example, the decomposition product can be contacted with a gas comprising H₂S and hydrogen, e.g., 10% H₂S/H₂, at elevated temperatures, for a period of time sufficient to sulfide the decomposition product (e.g., from about 5 minutes to about 150 hours, such as from about 10 minutes to about 96 hours, such as from about 20 minutes to about 24 hours), at the point of H₂S breakthrough in the exit gas. Sulfiding can also be effected, in situ, by passing a feedstock containing sulfur over the decomposition product.

If a binder material is used in the preparation of the catalyst composition of Formula (I), it can be any material that can be suitably applied as a binder in hydroprocessing catalysts. Examples may include silica, silica-alumina, silica-coated alumina, alumina-coated silica, alumina such as (pseudo)boehmite, or gibbsite, titania, zirconia, cationic clays or anionic clays such as saponite, bentonite, kaoline, sepiolite or hydrotalcite, or mixtures thereof. Suitable binders can be silica, silica-alumina, alumina, titanic, zirconia, or mixtures thereof, and may be applied as such or after peptization. Precursors of these binders can be applied during the process of the present disclosure, and can be converted into any of the above-described binders. Suitable precursors can be, e.g., alkali metal aluminates (to obtain an alumina binder), water glass (to obtain a silica binder), a mixture of alkali metal aluminates and water glass (to obtain a silica alumina binder), a mixture of sources of a di-, tri-, and/or tetravalent metal such as a mixture of water-soluble salts of magnesium, aluminum and/or silicon (to prepare a cationic clay and/or anionic clay), chlorohydrol, aluminum sulfate, or mixtures thereof.

The binder material may be composited with a group 6 metal and/or a group 8 metal, prior to being composited with the bulk catalyst composition of Formula (I) and/or prior to being added during the preparation thereof. Compositing the binder material with any of these metals may be carried out by impregnation of the solid binder with these materials, thus using any suitable impregnation techniques. If the binder is peptized, it is also possible to carry out the peptization in the presence of group 6 metal components and/or group 8 metal components.

If alumina is applied as binder, the surface area can be of from about 100 m²/g to about 400 m²/g, such as from about 150 m²/g to about 350 m²/g, as measured by the BET process. The pore volume of the alumina can be of from about 0.5 ml/g to about 1.5 ml/g, as measured by nitrogen adsorption.

The binder material to be added in the process of the present disclosure may have less catalytic activity than the bulk catalyst composition or no catalytic activity at all. Consequently, by adding a binder material, the activity of the bulk catalyst composition of Formula (I) may be reduced. Therefore, the amount of binder material to be added in the process of the present disclosure may depend on the activity of the final catalyst composition. Binder amounts from about 0.01 wt % to about 95 wt % of the total composition, such as from about 1 wt % to about 75 wt % of the total composition, such as from about 5 wt % to about 50 wt % of the total composition, such as from about 10 wt % to about 25 wt % of the total composition, alternatively from about 0.01 wt % to about 5 wt % of the total composition, such as from about 0.01 wt % to about 2 wt % of the total composition can be suitable, depending on the envisaged catalytic application. However, to take advantage of the resulting unusual high activity of the composition of the present disclosure, binder amounts to be added can be of about 0.5 wt % to about 75 wt % of the total composition.

The catalyst composition of Formula (I) can be directly shaped. Shaping may include extrusion, pelletizing, beading, and/or spray drying. It must be noted that if the catalyst composition is to be applied in slurry type reactors, fluidized beds, moving beds, expanded beds, or ebullating beds, spray drying or beading is applied for fixed bed applications, the catalyst composition can be extruded, pelletized and/or beaded. In the latter case, prior to or during the shaping process, any suitable additives that can be used to facilitate shaping can be added. Suitable additives may include aluminum stearate, surfactants, graphite, or mixtures thereof. Such additives can be added at any stage prior to the shaping process. Further, when alumina is used as a binder, acids (e.g., nitric acid) may be added prior to the shaping process, in order to increase the mechanical strength of the extrudates.

In at least one embodiment, a binder material is added prior to the shaping process. Further, the shaping process can be carried out in the presence of a liquid such as water. The amount of liquid in the extrusion mixture, expressed as LOI, can be of from about 20% to about 80%.

The resulting shaped catalyst composition can, after an optional drying process, be optionally calcined. If a calcination process is carried out, it can be done at a temperature of from about 100° C. to about 600° C., such as from about 350° C. to about 500° C., for a time varying from 30 minutes to about 48 hours. The drying of the shaped particles can be carried out at temperatures above 100° C.

In at least one embodiment, the catalyst composition of Formula (I) is subjected to spray drying, (flash) drying, milling, kneading, or combinations thereof, prior to shaping. These additional processes can be conducted either before or after a binder is added, after solid-liquid separation, before or after calcination and subsequent to re-wetting. Without being bound by theory, it is believed that by applying any of the above-described techniques of spray drying, (flash) drying, milling, kneading, or combinations thereof, the degree of mixing between the bulk catalyst composition of Formula (I) and the binder material can be improved. Such statement can apply to both cases where the binder material can be added before or after the application of any of the above-described processes. However, the binder material can be added prior to spray drying and/or any alternative technique. If the binder is added subsequent to spray drying and/or any alternative technique, the resulting composition can be thoroughly mixed by any conventional technique prior to shaping. For example, an advantage of spray drying is that no wastewater streams are obtained when such technique is applied.

Additional components to the catalyst compositions can be used for purposes of the present disclosure, such as catalyst compositions with hydrocracking capability. Furthermore, a cracking component may be added during the catalyst composition preparation. The cracking component can be any suitable cracking component, such as cationic clays, anionic clays, zeolites such as ZSM-5, (ultra-stable) zeolite Y, zeolite X, ALPO's, SAPO'S, amorphous cracking components such as silica-alumina, or mixtures thereof. Some materials may act as a binder and a cracking component at the same time. For instance, silica-alumina may have at the same time a cracking and a binding function.

The cracking component may be composited with a group 6 metal and/or a group 8-10 metal prior to being composited with the bulk catalyst composition and/or prior to being added during the preparation thereof. Compositing the cracking component with any of these metals may be carried out by impregnation of the cracking component with these materials.

The cracking component, which can be included at a cracking component content of from 0 wt % to about 80 wt %, based on the total weight of the catalyst, can be added at any stage of the process of the present disclosure, prior to the shaping process. However, the cracking component can be added during the compositing process with the binder.

Addition of a cracking component may depend on the envisaged catalytic application of the final catalyst composition of Formula (I) which of the above-described cracking components can be added. A zeolite can be added if the resulting composition shall be applied in hydrocracking or fluid catalytic cracking. Other cracking components such as silica-alumina or cationic clays can be added if the final catalyst composition shall be used in hydrotreating applications. The amount of cracking material that is added depends on the activity of the final catalyst composition and the application envisaged, and thus may vary from 0 wt % to about 80 wt %, based on the total weight of the catalyst composition.

Further materials can be added in addition to the metal components already added. Such materials may include any material that can be added during hydroprocessing catalyst preparation. Suitable examples of materials can be phosphorus compounds, boron compounds, fluorine-containing compounds, additional transition metals, rare earth metals, fillers, or mixtures thereof.

Suitable phosphorus compounds may include ammonium phosphate, phosphoric acid, or organic phosphorus compounds. Phosphorus compounds can be added at any stage of the process of the present disclosure prior to the shaping process and/or subsequent to the shaping process. If the binder material is peptized, phosphorus compounds can also be used for peptization. For instance, the binder can be peptized by contacting the binder with phosphoric acid or with a mixture of phosphoric and nitric acid.

Further materials can include any suitable additional transition metal. Suitable additional transition metals can be, for example, rhenium, ruthenium, rhodium, iridium, chromium, vanadium, iron, cobalt, platinum, palladium, cobalt, nickel, molybdenum, or tungsten. Nickel, molybdenum, and tungsten can be applied in the form of any of the water-insoluble nickel, molybdenum and/or tungsten components that are described above for the solid route. These metals can be added at any stage of the process of the present disclosure prior to the shaping process. Apart from adding these metals during the process of the present disclosure, composite the final catalyst composition therewith can be performed. For example, the final catalyst composition can be impregnated with an impregnation solution including any of these metals.

In at least one embodiment, the catalyst composition (A) includes the commercial hydroprocessing catalysts under the tradename NEBULA®.

### Catalyst Composition (B)

One aspect of the present disclosure relates to processes for hydroprocessing a hydrocarbon feedstock by using a catalyst precursor composition comprising at least one group 6 metal, at least one group 8-10 metal, impregnated with an amide reaction product formed from (i) a first organic compound containing at least one amine group, and (ii) a second organic compound separate from the first organic compound and containing at least one carboxylic acid group. A thermal treatment can be carried out following the impregnation of the amide into the metal oxide component in order to induce a controlled conversion of the amide into the final organic component of the catalyst precursor (which may contain additional unsaturation in excess of that in the impregnated amide and potentially additional oxygen when the treatment is carried out in an oxidizing atmosphere such as air). The thermal treatment may also be carried out under non-oxidizing conditions, e.g., in an inert gas such as nitrogen. The thermal treatment can be carried out at a temperature of from about 195° C. to about 250° C. Catalyst composition (B) can be a bulk mixed metal hydroprocessing catalyst composition which can be produced from the bulk mixed metal oxide catalyst precursor described above, thus by a sulfiding process of the bulk mixed metal oxide catalyst precursor. The sulfidation can begin after impregnation into the metal oxide component and following the thermal treatment process in the presence of the amide or the oxidized form of the amide.

The amide-containing catalyst precursor composition is made by a process comprising: (a) impregnating the metal oxide component of the catalyst precursor comprising one or more group 6 metals, one or more group 8-10 metals, with an amide formed from a first organic compound containing at least one amine group and a second organic compound separate from the first organic compound and containing at least one carboxylic acid group to form an organically treated precursor catalyst composition; (b) heating such precursor composition at a temperature of from about 195° C. to about 250° C., such as from about 200° C. to about 230° C., for a suitable time period in which the resulting amide does not decompose, such as at a time period of from about 5 minutes to about 200 hours, such as 10 minutes to about 96 hours, such as from about 10 minutes to about 48 hours, such as 10 minutes to about 24 hours, such as from about 10 minutes to about 12 hours, such as 10 minutes to about 6 hours. In at least one embodiment, the resulting product is a thermally-treated catalyst precursor which may then be sulfided to form the active catalyst composition, such as an active HDS catalyst composition.

The process described above can be used to make a bulk metal catalyst precursor composition or a supported metal catalyst precursor composition. When used to make a bulk mixed metal catalyst precursor composition, the amide-containing catalyst precursor composition can, in at least one embodiment, include the thermally treated amide reaction product, one or more oxide forms of the group 6 metals, one or more oxide forms of the group 8-10 metals, and optionally about 20 wt % or less of a binder.

The group 6 metal components may suitably be Mo and/or W, and the group 8-10 metal component can suitably be Co and/or Ni. The catalyst precursor can further include one or more group 5 metals, such as V and/or Nb.

The first organic compound can include at least 10 carbon atoms, such as the first organic compound can include a primary monoamine having from 10 carbon atoms to 30 carbon atoms. The second organic compound can include at least 10 carbon atoms, such as the second organic compound can include only one carboxylic acid group and can have from carbon atoms 10 to 30 carbon atoms.

The bulk catalyst compositions may have little to no carrier or support material included in their compositions (e.g., about 20 wt % or less, such as about 15 wt % or less, such as about 10 wt % or less, such as about 5 wt % or less, or substantially no carrier or support, based on the total weight of the catalyst composition). For instance, bulk hydroprocessing catalyst compositions may contain a minor amount of a binder (e.g., about 20 wt % or less, such as about 15 wt % or less, such as about 10 wt % or less, such as about 5 wt % or less, or substantially no carrier or support, based on the total weight of the catalyst composition) to improve the physical and/or thermal properties of the catalyst compositions. In contrast, supported catalyst systems may include a carrier or support onto which one or more catalytically active materials can be deposited, for example, by using an impregnation or coating technique. Nevertheless, heterogeneous catalyst systems without a carrier or support (or with a minor amount of carrier or support) can be referred to as bulk catalysts and are frequently formed by co-precipitation techniques.

When the catalyst precursor is a bulk mixed metal catalyst precursor composition, the thermal treatment of the amide-impregnated metal oxide component can be carried out by heating the impregnated composition to a temperature from about 195° C. to about 250° C.; for a time which does not result in decomposition of the amide, although additional unsaturation may arise from partial in situ decomposition. The bulk mixed metal hydroprocessing catalyst composition (B) can be produced from the precursor described above by sulfiding the precursor, with the sulfiding process taking place with the amide present on the metal oxide component (e.g., when the thermally treated amide, is substantially present and/or not significantly decomposed by the beginning of the sulfiding process). Additional unsaturation may be present in the organic component of the catalyst precursor resulting from a variety of mechanisms including partial decomposition, (e.g., via oxidative dehydrogenation in the presence of oxygen and/or via non-oxidative dehydrogenation in the absence of an appropriate concentration of oxygen), of unfunctionalized organic portions of the amide and/or through conjugation/aromatization of unsaturations expanding upon an unsaturated portion the amide. The treated organic component may also contain additional oxygen in addition to the unsaturation when the treatment is carried out in an oxidizing atmosphere.

Catalyst precursor compositions and hydroprocessing catalyst composition (B) of the present disclosure can include (or can have metal oxide components that may include) at least one oxide form of a group 6 metal or one or more group 6 metals, and at least one oxide form of a group 8-10 metal or one or more group 8-10 metals, and optionally at least one oxide of a group 5 metal or one or more group 5 metals. The group 5, 6, 8, 9, and/or 10 metals can be present in their substantially fully oxidized form, which can take the form of simple metal oxides, but which may be present in a variety of other oxide forms, e.g., such as hydroxides, oxyhydroxides, oxycarbonates, carbonates, oxynitrates, oxysulfates, or combination thereof. In at least one embodiment, the group 6 metals are Mo and/or W, and the group 8-10 metals are Co and/or Ni. The atomic ratio of the group 6 metals to the group 8-10 metals can be from about 2:1 to about 1:3, such as from about 5:4 to about 1:2, such as from about 5:4 to about 2:3, such as from about 5:4 to about 3:4, such as from about 10:9 to about 1:2, such as from about 10:9 to about 2:3, such as from about 10:9 to about 3:4, such as from about 20:19 to about 2:3, alternatively from about 20:19 to about 3:4. When the composition further includes at least one group 5 metal, that at least one metal can suitably be V and/or Nb. When present, the amount of group 5 metals can be such that the atomic ratio of the group 6 metals to the group 5 metals can be from about 99:1 to about 1:1, such as from about 99:1 to about 5:1, such as from about 99:1 to about 10:1, alternatively from about 99:1 to about 20:1. Additionally or alternately, when one or more group 5 metals are present, the atomic ratio of the sum of the group 5 metals plus the group 6 metals compared to the group 8-10 metals can be from about 2:1 to about 1:3, such as from about 5:4 to about 1:2, such as from about 5:4 to about 2:3, such as from about 5:4 to about 3:4, such as from about 10:9 to about 1:2, such as from about 10:9 to about 2:3, such as from about 10:9 to about 3:4, such as from about 20:19 to about 2:3, alternatively from about 20:19 to about 3:4.

The metals forming the metal oxide component in the catalyst precursor compositions and in the hydroprocessing catalyst compositions 2 according to the present disclosure can be present in any suitable form prior to sulfiding, but can be present as metal oxides. When provided as bulk mixed metal oxides, the bulk oxide components of the catalyst precursor compositions and of the hydroprocessing catalysts can be prepared by any suitable process, such as produced by forming a slurry, such as an aqueous slurry, comprising: (1) (a) an oxyanion of the group 6 metals, such as a tungstate and/or a molybdate, or (b) an insoluble (oxide, acid) form of the group 6 metals, such as tungstic acid and/or molybdenum trioxide; (2) a salt of the group 8-10 metals, such as nickel carbonate; and optionally, when present, (3) (a) a salt or oxyanion of a group 5 metal, such as a vanadate and/or a niobate, or (b) insoluble (oxide, acid) form of a group 5 metal, such as niobic acid and/or diniobium pentoxide. The slurry can be heated to a suitable temperature, such as from about 60° C. to about 150° C. at a suitable pressure, e.g., at atmospheric or autogenous pressure, for an appropriate time, such as from about 4 hours to about 24 hours.

Non-limiting examples of suitable mixed metal oxide compositions can include nickel-tungsten oxides, cobalt-tungsten oxides, nickel-molybdenum oxides, cobalt-molybdenum oxides, nickel-molybdenum-tungsten oxides, cobalt-molybdenum-tungsten oxides, cobalt-nickel-tungsten oxides, cobalt-nickel-molybdenum oxides, cobalt-nickel-tungsten-molybdenum oxides, nickel-tungsten-niobium oxides, nickel-tungsten-vanadium oxides, cobalt-tungsten-vanadium oxides, cobalt-tungsten-niobium oxides, nickel-molybdenum-niobium oxides, nickel-molybdenum-vanadium oxides, nickel-molybdenum-tungsten-niobium oxides, nickel-molybdenum-tungsten-vanadium oxides, and combinations thereof.

Suitable mixed metal oxide compositions can advantageously exhibit a specific surface area (as measured via the nitrogen BET process using a Quantachrome Autosorb™ apparatus) of at least about 20 m²/g, such as at least about 30 m²/g, such as at least about 40 m²/g, such as at least about 50 m²/g, such as at least about 60 m²/g, such as at least about 70 m²/g, such as at least about 80 m²/g. Additionally or alternatively, the mixed metal oxide compositions can exhibit a specific surface area of about 500 m²/g or less, such as about 400 m²/g or less, such as about 300 m²/g or less, such as about 250 m²/g or less, such as about 200 m²/g or less, such as about 175 m²/g or less, such as about 150 m²/g or less, such as about 125 m²/g or less, such as about 100 m²/g or less.

After separating and drying the mixed metal oxide (slurry) composition, the resulting catalyst composition can be treated, by impregnation, with the pre-formed amide derived from (i) the first organic compound including at least one amine group, and (ii) the second organic compound separate from the first organic compound and including at least one carboxylic acid group. The amide can be formed by a condensation reaction between the amine reactant and the carboxylic acid reactant; such condensation reaction, carried out ex situ, can be accomplished at mildly elevated temperatures.

The amine from which the amide is formed can have at least 10 carbon atoms, such as from about 10 carbon atoms to about 20 carbon atoms, such as from about 10 carbon atoms to about 30 carbon atoms. The amine from which the amide is formed can include a primary monoamine having from about 10 carbon atoms to about 30 carbon atoms. The carboxylic acid used to form the amide can include at least 10 carbon atoms, such as from about 10 carbon atoms to about 20 carbon atoms, such as from about 10 carbon atoms to about 30 carbon atoms and may include only one carboxylic acid group. Additionally or alternatively, the total number of carbon atoms included by both the acid and amine reactants used to form the amide can be at least 15 carbon atoms, such as at least 20 carbon atoms, such as at least 25 carbon atoms, such as at least 30 carbon atoms, such as at least 35 carbon atoms. Although in such embodiments there may be no practical upper limit on total carbon atoms from both organic compounds, in at least one embodiment, the total number of carbon atoms included among both the first and second organic compounds can be about 100 carbon atoms or less, such as 80 carbon atoms or less, such as 70 carbon atoms or less, such as 60 carbon atoms or less, such as 50 carbon atoms or less.

Representative examples of organic compounds including amine groups can include primary and/or secondary, linear, branched, and/or cyclic amines, such as triacontanylamine, octacosanylamine, hexacosanylamine, tetracosanylamine, docosanylamine, erucylamine, eicosanylamine, octadecylamine, oleylamine, linoleylamine, hexadecylamine, sapienylamine, palmitoleylamine, tetradecylamine, myristoleylamine, dodecylamine, decylamine, nonylamine, cyclooctylamine, octylamine, cycloheptylamine, heptylamine, cyclohexylamine, n-hexylamine, isopentylamine, n-pentylamine, t-butylamine, n-butylamine, isopropylamine, n-propylamine, adamantanamine, adamantanemethylamine, pyrrolidine, piperidine, piperazine, imidazole, pyrazole, pyrrole, pyrrolidine, pyrroline, indazole, indole, carbazole, norbornylamine, aniline, pyridylamine, benzylamine, aminotoluene, alanine, arginine, aspartic acid, glutamic acid, glutamine, glycine, histidine, isoleucine, leucine, lysine, phenylalanine, serine, threonine, valine, 1-amino-2-propanol, 2-amino-1-propanol, diaminoeicosane, diaminooctadecane, diaminohexadecane, diaminotetradecane, diaminododecane, diaminodecane, 1,2-diaminocyclohexane, 1,3-diaminocyclohexane, 1,4-diaminocyclohexane, ethylenediamine, ethanolamine, p-phenylenediamine, o-phenylenediamine, m-phenylenediamine, 1,2-propylenediamine, 1,3-propylenediamine, 1,4-diaminobutane, 1,3 diamino-2-propanol, and combinations thereof. In at least one embodiment, the molar ratio of the group 6 metals in the composition to the first organic compound during treatment can be from about 1:1 to about 20:1.

The amine functionality can include primary or secondary amines, as mentioned above, but might not include tertiary or quaternary amines, as tertiary and quaternary amines tend not to be able to form amides. Furthermore, the amine compound can contain other functional groups besides amine, whether or not they are capable of participating in forming an amide or other condensation reaction product the carboxylic acid compound. For instance, the first organic compound can include an aminoacid, which possesses an amine functional group and a carboxylic acid functional group simultaneously. In such an instance, the aminoacid would qualify as only one of the organic compounds, and not both; thus, in such an instance, either an additional amine-containing (first) organic compound would need to be present (in the circumstance where the aminoacid would be considered the second organic compound) or an additional carboxylic acid-containing (second) organic compound would need to be present (in the circumstance where the aminoacid would be considered the first organic compound). Aside from carboxylic acids, other examples of such secondary functional groups in amine-containing organic compounds can include hydroxyls, aldehydes, anhydrides, ethers, esters, imines, imides, ketones, thiols (mercaptans), thioesters, and combinations thereof.

Additionally or alternately, the amine portion of the first organic compound can be a part of a larger functional group in that compound, so long as the amine portion (notably the amine nitrogen and the constituents attached thereto) retains the capability of participating in forming an amide or other condensation reaction product with one or more of the functional groups from second organic compound. For instance, the first organic compound can include a urea, which functional group includes an amine portion attached to the carbonyl portion of an amide group. In such instance, provided the amine portion of the urea functional group of the first organic compound would still be able to undergo a condensation reaction with the carboxylic acid functional group of the second organic compound, then the urea can be considered functionally as an “amine-containing” functional group for the purposes of the present disclosure, except in situations where such inclusion is specifically contradicted. Aside from ureas, other examples of such amine-containing functional groups that may be suitable for satisfying the at least one amine group in the first organic compound can include hydrazides, sulfonamides, and combinations thereof.

Representative examples of organic compounds containing carboxylic acids can include primary and/or secondary, linear, branched, and/or cyclic acids, such as triacontanoic acid, octacosanoic acid, hexacosanoic acid, tetracosanoic acid, docosanoic acid, erucic acid, docosahexanoic acid, eicosanoic acid, eicosapentanoic acid, arachidonic acid, octadecanoic acid, oleic acid, elaidic acid, stearidonic acid, linoleic acid, alpha-linolenic acid, hexadecanoic acid, sapienic acid, palmitoleic acid, tetradecanoic acid, myristoleic acid, dodecanoic acid, decanoic acid, nonanoic acid, cyclooctanoic acid, octanoic acid, cycloheptanoic acid, heptanoic acid, cvclohexanoic acid, hexanoic acid, adamantanecarboxylic acid, norbornaneacetic acid, benzoic acid, salicylic acid, acetylsalicylic acid, citric acid, maleic acid, malonic acid, glutaric acid, lactic acid, oxalic acid, tartaric acid, cinnamic acid, vanillic acid, succinic acid, adipic acid, phthalic acid, isophthalic acid, terephthalic acid, ethylenediaminetetracarboxylic acids (such as ethylenediaminetetraacetic acid, also referred to as EDTA), fumaric acid, alanine, arginine, aspartic acid, glutamic acid, glutamine, glycine, histidine, isoleucine, leucine, lysine, phenylalanine, serine, threonine, valine, 1,2-cyclohexanedicarboxylic acid, 1,3-cyclohexanedicarboxylic acid, 1,4-cyclohexanedicarboxylic acid, and combinations thereof. In at least one embodiment, the molar ratio of the group 6 metals in the composition to the second organic compound during treatment can be from about 3:1 to about 20:1.

The acid reactant can contain other functional groups besides carboxylic acids, whether or not they are capable of participating in forming an amide or other condensation reaction product with one or more of the functional groups from the first organic compound. For example, the second organic compound can include an amino acid, which possesses a carboxylic acid functional group and an amine functional group simultaneously. In such an instance, the amino acid would qualify as only one of the organic compounds, and not both; thus, in such an instance, either an additional amine-containing (first) organic compound would need to be present (in the circumstance where the amino acid would be considered the second organic compound) or an additional carboxylic acid-containing (second) organic compound would need to be present (in the circumstance where the amino acid would be considered the first organic compound). Aside from amines, other examples of such secondary functional groups in carboxylic acid-containing organic compounds can include hydroxyls, aldehydes, anhydrides, ethers, esters, imines, imides, ketones, thiols (mercaptans), thioesters, and combinations thereof.

The reactive portion of the second organic compound can be a part of a larger functional group in that compound and/or can be a derivative of a carboxylic acid that behaves similarly enough to a carboxylic acid in the presence of the amine functional group of the first organic compound, such that the reactive portion and/or derivative retains the capability of participating in forming an amide or other condensation reaction product with one or more of the functional groups from the first organic compound. One example of a carboxylic acid derivative can include an alkyl carboxylate ester, where the alkyl group does not substantially hinder (over a reasonable time scale) the condensation reaction between the amine and the carboxylate portion of the ester to form an amide.

The amide is formed prior to impregnation into the metal oxide component of the catalyst precursor by reaction of the amine component and the carboxylic acid component. Such reaction can take place readily at mildly elevated temperatures up to about 200° C., with liberation of water as a by-product of the reaction at temperatures above 100° C. , such as above 150° C. The reactants can be heated together to form a melt in which the reaction can take place and the melt impregnated directly into the metal oxide component which can be pre-heated to the same temperature as the melt in order to assist penetration into the structure of the metal oxide component. The reaction can also be carried out in the presence of a solvent and the resulting solution can be used for the impregnation process. The amide and its heat treated derivative may not be located/incorporated within the crystal lattice of the mixed metal oxide precursor, e.g., may instead be located on the surface and/or within the pore volume of the precursor and/or be associated with (bound to) one or more metals or oxides of metals in a manner that does not significantly affect the crystalline lattice of the mixed metal oxide precursor composition, as observed through XRD and/or other crystallographic spectra. A sulfided form of the mixed metal oxide precursor composition can still have its sulfided form affected by the organic compound(s)/additive(s) and/or the reaction product(s), even though the oxide lattice is not significantly affected.

There is not a strict limit on the ratio between the amine reactant and the carboxylic reactant, and accordingly, the ratio of the reactive amine and carboxylic acid groups in the two reactants may vary, respectively, from about 1:4 to about 4:1, such as from about 1:3 to about 3:1, such as from about 1:2 to about 2:1. It has been observed that catalysts made with amides from equimolar quantities of the amine and carboxylic acid reactants compounds show performance improvements in hydroprocessing certain feeds and for this reason, amides made with an equimolar ratio are suitable components for one or more processes of the present disclosure.

The pre-formed amide can be suitably impregnated into the metal oxide precursor by incipient wetness impregnation with the amount determined according to the pore volume of the metal oxide component. Following impregnation a heat treatment can be carried out, which first can remove any residual water and/or solvent but also can create a reaction product including additional unsaturation sites and possibly additional oxygen. The amide-impregnated metal oxide component can then be heated at a sufficient temperature and for a sufficient time to form a product containing the additional unsaturation which is characteristic of the organic component; such treatment with the pre-formed amide can be from about 195° C. to about 250° C., such as from about 200° C. to about 230° C.

The heating process should not be conducted for so long that the amide becomes substantially decomposed. The heating process can be conducted for a sufficiently long time to form additional unsaturation(s), which may result from at least partial decomposition (e.g., oxidative and/or non-oxidative dehydrogenation and/or aromatization) of some (unfunctionalized organic) portions of the organic compounds. On the other hand, the heating should not be conducted for so long that the decomposition substantially can decompose the amide or any condensation product. The impregnated catalyst precursor composition can be heated to a temperature high enough to form the unsaturated reaction product and high enough to enable any byproducts (e.g., water) to be removed, the temperature to which the impregnated precursor composition is heated should, however, maintained low enough so as to substantially retain the amide reaction product with the additional unsaturations and any oxygen, and so as not to significantly decompose the functionalized reaction product, and/or so as not to significantly volatilize (more than 50% by weight of) the amide.

The specific lower and upper temperature limits based on the above considerations can be dependent upon a variety of factors that can include the atmosphere under which the heating can be conducted, the chemical and/or physical properties of the amide, the amide reaction product, and/or any functionalized reaction byproduct. The heating temperature can, for example, suitably be at least about 120° C. such as at least about 150° C., such as at least about 165° C., such as at least about 175° C., such as at least about 185° C., such as at least about 195° C., such as at least about 200° C., such as at least about 210° C., such as at least about 220° C., such as at least about 230° C., such as at least about 240° C., such as at least about 250° C. The heating temperature can be about 400° C. or less, such as about 375° C. or less, such as about 350° C. or less, such as about 325° C. or less, such as about 300° C. or less, such as about 275° C. or less, such as about 250° C. or less, such as about 240° C. or less, such as about 230° C. or less, such as about 220° C. or less, such as about 210° C. or less, such as about 200° C. or less. The temperature to be used should be selected on an empirical basis depending on the nature of the amide used in the impregnation. The progress of the heating can be monitored according to the properties of the treated product, including analysis by GC-MS and by its infrared spectrum as described below.

The heating can be conducted in a low-oxidizing atmosphere or non-oxidizing atmosphere (such as an inert atmosphere, such as in the presence of nitrogen). Alternatively, the heating can be conducted in a moderately-oxidizing atmosphere or highly-oxidizing atmosphere. Heating in air can be a convenient procedure which can further result in the incorporation of additional oxygen into the reaction product when the treatment is carried out in air or another oxidizing atmosphere. The heating can be carried out in a multi-step procedure in which one or more heating steps can be conducted in the low- or non-oxidizing atmosphere, in which one or more heating steps can be conducted in the moderately- or highly-oxidizing atmosphere, or both.

The period of time for the heating in the atmosphere can be from about 5 minutes to about 168 hours, such as from about 10 minutes to about 96 hours, such as from about 10 minutes to about 24 hours, such as from about 10 minutes to about 12 hours, such as from about 10 minutes to about 6 hours, such as from about 20 minutes to about 96 hours, such as from about 20 minutes to about 24 hours, such as from about 20 minutes to about 12 hours, such as from about 20 minutes to about 6 hours, such as from about 30 minutes to about 96 hours, such as from about 30 minutes to about 24 hours, such as from about 30 minutes to about 12 hours, such as from about 30 minutes to about 6 hours, such as from about 45 minutes to about 96 hours, such as from about 45 minutes to about 24 hours, such as from about 45 minutes to about 12 hours, such as from about 45 minutes to about 6 hours, such as from about 1 hour to about 96 hours, such as from about 1 hour to about 24 hours, such as from about 1 hour to about 12 hours, such as from 1 hour to about 6 hours, such as from about 1 hour to about 4 hours.

When used to make a bulk mixed metal catalyst precursor composition, the catalyst precursor composition can be stated to include the thermally treated amide reaction product, an oxide form of the group 6 metal, an oxide form of the group 8-10 metal, and optionally about 20 wt % or less of a binder (e.g., about 10 wt % or less). The organic-containing thermally treated catalyst precursor composition containing the reaction product can contain from about 4 wt % to about 20 wt %, such as from about 5 wt % to about 15 wt %, carbon resulting from the amide and/or its reaction product, based on the total weight of the relevant composition.

As a result of the heating process, the reaction product from the organically treated catalyst precursor can exhibit a content of unsaturated carbon atoms (which may include aromatic carbon atoms), as measured according to peak area comparisons using ¹³C-NMR techniques, of at least 29%, based on the total carbon atoms, such as at least about 30%, such as at least about 31%, such as at least about 32%, such as at least about 33%; such content of unsaturated carbon atoms can vary up to about 70%, such as up to about 65%, such as up to about 60%, such as up to about 55%, such as up to about 50%, such as up to about 45%, such as up to about 40%, such as up to about 35%. Still further additionally or alternately, as a result of the heating process, and as compared to the non-thermally treated catalyst precursor composition, the reaction product from the organically treated catalyst precursor can exhibit an increase in content of unsaturated carbon atoms (which may include aromatic carbon atoms), as measured according to peak area comparisons using ¹³C-NMR techniques, of at least about 17%, based on the total carbon atoms, such as at least about 18%, such as at least about 19%, such as at least about 20%, such as at least about 21% (e.g., in an embodiment where the first organic compound is oleylamine and the second organic compound is oleic acid, such that the combined unsaturation level of the unreacted compounds is about 11.1% of carbon atoms, an about 17% increase in unsaturated carbons upon heating corresponds to about 28.1% content of unsaturated carbon atoms in the reaction product). Such increase in unsaturated carbon atoms may vary up to about 60%, based on the total carbon atoms, such as up to about 55%, such as up to about 50%, such as up to about 45%, such as up to about 40%, such as up to about 35%, such as up to about 30%, such as up to about 25%.

In at least one embodiment, the thermally treated organic catalyst precursor characteristically exhibits a ratio of unsaturated carbon atoms to aromatic carbon atoms, as measured according to peak area ratios using infrared spectroscopic techniques, of a deconvoluted peak centered from about 1700 cm⁻¹ to about 1730 cm⁻¹ (e.g., at about 1715 cm⁻¹), compared to a deconvoluted peak centered from about 1380 cm⁻¹ to about 1450 cm⁻¹ (e.g., from about 1395 cm⁻¹ to about 1415 cm⁻¹), of at least 0.9. Such ratio of unsaturated carbon atoms to aromatic carbon atoms may be higher, for example at least 1, such as at least 1.1, such as at least 1.2, such as at least 1.3, such as at least 1.4, such as at least 1.5, such as at least 1.7, such as at least 2, such as at least 2.2, such as at least 2.5, such as at least 2.7, such as at least 3. Much higher ratios up to 15 may be observed, such as up to 10, such as up to 8, such as up to 7, such as up to 6, such as up to 5, such as up to 4.5, such as up to 4, such as up to 3.5, such as up to 3. When the treatment is carried out in an oxidizing atmosphere (e.g., air), bands in the 1710 cm⁻¹ to 1730 cm⁻¹ range can be formed, such as at 1710 cm⁻¹ (which is not present in the initial amide but appears in the treated, active catalyst precursor). The growth of the peak at 1710 cm⁻¹ can be used to monitor the progress of the heat treatment in order to achieve the desired degree of activation brought on by the treatment.

Without being bound by theory, it is believed that the pre-formed amide and/or additional unsaturation(s) present when the catalyst precursor is sulfided to form the final active sulfided (hydroprocessing) catalyst assist somehow in controlling one or more of the following: the size of sulfided crystallites; the coordination of one or more of the metals during sulfidation, such that a higher proportion of the one or more types of metals are in appropriate sites for promoting suitable hydroprocessing reactions (such as hydrotreating, hydrodenitrogenation, hydrodesulfurization, hydrodeoxygenation, hydrodemetallation, hydrocracking including selective hydrocracking, hydroisomerization, hydrodewaxing), and combinations thereof, and/or for reducing/minimizing undesired hydroprocessing reactions, such as aromatic saturation, hydrogenation of double bonds, and combinations thereof) than for sulfided catalysts made in the absence of the thermally treated amide reaction product. Coordination/catalysis involving one or more of the metals after sulfidation, is believed to proceed with a higher proportion of the form(s) in which the metals are present or that they are present in a form which is more efficient at promoting the appropriate hydroprocessing reactions (e.g., because the higher proportion of metal sites can catalyze more hydrodesulfurization reactions of the same type in a given timescale and/or because the higher proportion of the metal sites can catalyze more difficult hydrodesulfurization reactions in a similar timescale).

The active sulfided hydroprocessing catalyst composition can be produced by sulfiding the catalyst precursor composition. Sulfiding can be carried out by contacting the catalyst precursor composition containing the amide and/or its oxidized reaction product with a sulfur-containing compound (e.g., elemental sulfur, hydrogen sulfide, polysulfides, which may originate from a fossil/mineral oil stream, from a biocomponent-based oil stream, from a combination thereof, or from a sulfur-containing stream separate from the aforementioned oil stream(s)), at a temperature and for a time sufficient to substantially sulfide the composition and/or sufficient to render the sulfided composition active as a hydroprocessing catalyst (e.g., temperature of from about 300° C. to about 400° C.). For instance, the sulfidation can be carried out at a temperature from about 300° C. to about 400° C., such as from about 310° C. to about 350° C., for a period of time from about 30 minutes to about 96 hours, such as from about 1 hour to about 48 hours, such as from about 4 hours to about 24 hours. The sulfiding can be conducted before or after combining the metal (oxide) containing composition with a binder, if desired, and before or after forming the composition into a shaped catalyst. The sulfiding can additionally or alternately be conducted in situ in one or more hydroprocessing reactors. The initial or primary stage of the sulfiding process should be carried out with the amide with its additional unsaturation and added oxygen present.

The entire amount of the organic component may not last through the entire sulfidation in which temperatures up to about 400° C., such as about 340° C., may be encountered, but entire amount of the organic component may be present during the sulfidation of the surface of the oxide, for example of about 220° C. to about 235° C. and some amount of the organic component may remain even after the final high temperature stage of the sulfidation (e.g., about 15% to about 50% of the weight of the starting organic can remain in one form or another). The oxide can be quantitatively converted to the sulfide during the sulfiding process although a small amount of residual oxide may remain.

The sulfided catalyst composition may exhibit a layered structure including a plurality of stacked YS₂ layers, where Y is one or more group 6 metals, such that the average number of stacks (such as for bulk organically treated catalysts) can be from about 1.5 to about 3.5, such as from about 1.5 to about 3.0, such as from about 2 to about 3.3, such as from about 2 to about 3, such as from about 2.1 to about 2.8. For instance, the treatment of the metal (oxide) containing precursor composition according to the present disclosure can afford a decrease in the average number of stacks of the treated precursor of at least about 0.8, such as at least about 1, such as at least about 1.2, such as at least about 1.3, such as at least about 1.4, such as at least about 1.5, as compared to an untreated metal (oxide) including a precursor composition. Accordingly, the number of stacks can be considerably less than that obtained with an equivalent sulfided mixed metal (oxide) containing precursor composition produced without the amide and the heat treatment.

As described in U.S. Pub. No. 2018/0264450 A1, which is fully incorporated herein by reference, the reduction in the average number of stacks can be evidenced, e.g., via X-ray diffraction spectra of relevant sulfided compositions, in which the peak of the sulfide appears significantly broader (as determined by the same width at the half-height of the peak) than the corresponding peak in the spectrum of the sulfided mixed metal (oxide) containing precursor composition produced without the present organic treatment. Additionally or alternately to X-ray diffraction, transmission electron microscopy (TEM) can be used to obtain micrographs of relevant sulfided compositions, including multiple microcrystals, within which micrograph images the multiple microcrystals can be visually analyzed for the number of stacks in each, which can then be averaged over the micrograph visual field to obtain an average number of stacks that can evidence a reduction in average number of stacks compared to a sulfided mixed metal oxide precursor produced without the organic treatment (and/or, in certain cases, with only a single organic compound treatment).

The sulfided catalyst composition described above can be used as a hydroprocessing catalyst, either alone or in combination with a binder. If the sulfided catalyst composition is a bulk catalyst, then only a relatively small amount of binder might be added (e.g., less than 40 wt %, such as less than 20 wt %). However, if the sulfided catalyst composition is a heterogeneous/supported catalyst, then the binder can be a significant portion of the catalyst composition, e.g., at least about 40 wt %, such as at least about 50 wt %, such as at least about 60 wt %, such as at least about 70 wt %. Additionally or alternately for heterogeneous/supported catalysts, the binder can include up to about 95 wt % of the catalyst composition, such as up to about 90 wt %, such as up to about 85 wt %, such as up to about 80 wt %, such as up to about 75 wt %, such as up to about 70 wt %. Non-limiting examples of suitable binder materials can include silica, silica-alumina (e.g., conventional silica-alumina, silica-coated alumina, alumina-coated silica, or a combination thereof), alumina (e.g., boehmite, pseudo-boehmite, gibbsite, or a combination thereof), titania, zirconia, cationic clays or anionic clays (e.g., saponite, bentonite, kaoline, sepiolite, hydrotalcite, or a combination thereof), and mixtures thereof. In at least one embodiment, the binder includes silica, silica-alumina, alumina, titania, zirconia, and mixtures thereof. These binders may be applied as such or after peptization. It may also be possible to apply precursors of these binders that, during precursor synthesis, can be converted into any of the above-described binders. Suitable precursors can include, e.g., alkali metal aluminates (such as alumina binder), water glass (such as silica binder), a mixture of alkali metal aluminates and water glass (such as silica-alumina binder), a mixture of sources of a di-, tri-, and/or tetravalent metal, such as a mixture of water-soluble salts of magnesium, aluminum, and/or silicon (cationic clay and/or anionic clay), chlorohydrol, aluminum sulfate, or mixtures thereof.

For example, the binder material to be used can have lower catalytic activity than the remainder of the catalyst composition, or can have substantially no catalytic activity at all (less than about 5%, based on the catalytic activity of the bulk catalyst composition being about 100%). The amount of binder material to be used, at least in bulk catalysts, can depend on the suitable activity of the final catalyst composition. Binder amounts up to about 25 wt % of the total composition can be suitable (when present, from above 0 wt % to about 25 wt %), depending on the envisaged catalytic application. However, to take advantage of the resulting unusual high activity of bulk catalyst compositions according to the present disclosure, binder amounts, when added, can be from about 0.5 wt % to about 20 wt % of the total catalyst composition.

The binder material can be composited with a source of a group 6 metal and/or a source of a group 8-10 metal, prior to being composited with the bulk catalyst composition and/or prior to being added during the preparation thereof. Compositing the binder material with any of these metals may be carried out by any suitable means, e.g., impregnation of the (solid) binder material with these metal(s) sources.

A cracking component may also be added during the catalyst composition preparation.

When used, the cracking component can represent from about 0.5 wt % to about 30 wt %, such as from about 1 wt % to about 25 wt %, such as from about 5 wt % to about 20 wt %, such as from about 10 wt % to about 15 wt %, based on the total weight of the catalyst composition. Any suitable cracking components can be used, e.g., a cationic clay, an anionic clay, a zeolite (such as, for example, ZSM-5, zeolite Y, ultra-stable zeolite Y, zeolite X, an AlPO, a SAPO, or a combination thereof), amorphous cracking components (e.g., silica-alumina), or a combination thereof. It is to be understood that some materials may act as a binder and a cracking component at the same time. For instance, silica-alumina may simultaneously have both a cracking and a binding function.

The cracking component may be composited with a group 6 metal and/or a group 8-10 metal, prior to being composited with the catalyst composition and/or prior to being added during the preparation thereof. Compositing the cracking component with any of these metals may be carried out by any suitable means, e.g., impregnation of the cracking component with these metal(s) sources. When both a cracking component and a binder material are used and when compositing of additional metal components is desired on both, the compositing may be done on each component separately or may be accomplished by combining the components and doing a single compositing process.

The selection of particular cracking components, if any, can depend on the intended catalytic application of the final catalyst composition. For instance, a zeolite can be added if the resulting composition is to be applied in hydrocracking or fluid catalytic cracking (FCC). Other cracking components, such as silica-alumina or cationic clays, can be added if the final catalyst composition is to be used in hydrotreating applications. The amount of added cracking material can depend on the desired activity of the final composition and the intended application, and thus, when present, may vary from 0 wt % to about 80 wt %, such as from about 1 wt % to about 70 wt %, such as from about 5 wt % to about 60 wt %, such as from about 10 wt % to about 50 wt %, based on the total weight of the catalyst composition. In at least one embodiment, the combination of cracking component and binder material includes less than 50 wt % of the catalyst composition, such as less than about 40 wt %, such as less than about 30 wt %, such as less than about 20 wt %, such as less than about 15 wt %, such as less than about 10 wt %.

Further materials can be added, in addition to the metal components already added, such as any material that would be added during any suitable hydroprocessing catalyst preparation. Suitable examples of such further materials can include phosphorus compounds, boron compounds, fluorine-containing compounds, sources of additional transition metals, sources of rare earth metals, fillers, or mixtures thereof.

Evaluation of the effectiveness of the amide impregnation and thermal treatment can be based on the relative catalytic activity for a given reaction process (e.g., hydrodenitrogenation, hydrodesulfurization, hydrodeoxygenation). Such relative catalytic activity can further be expressed by comparing standard catalyst characteristics, such as weight, volume, moles of a certain (active metal) component, to normalize the results for universal comparison amongst catalysts, catalyst compositions and catalyst systems suitable in that given reaction process. Even so, such standard characteristics may not be universally comparable for example, because supported catalysts tend to have most of their catalytically active metal sites spread out over the support surface (and thus available for catalyzation). Thus, comparison of relative activities between supported catalysts and bulk catalysts may be inappropriate or uninformative, since proportionally fewer of the catalytically active metal sites in a bulk catalyst may be disposed on the surface (and thus available for catalyzation).

In at least one embodiment, the catalyst composition (B) includes the commercial hydroprocessing catalysts under the tradename Celestial®.

### Process

The present disclosure provides processes for hydroprocessing a hydrocarbon feedstock. In at least one embodiment, hydroprocessing includes introducing a hydrocarbon feedstock including a Si content of at least about 1 wppm (e.g., Si content of from about 1 wppm to about 150 wppm), based on the total weight of the hydrocarbon feedstock; introducing a treat gas (e.g., hydrogen) to the hydrocarbon feedstock to produce a hydrocarbon feedstock/treat gas mixture (e.g., where the treat gas is dissolved in the mixture to provide a feed mixture); and introducing the hydrocarbon feedstock/treat gas mixture (e.g., the feed mixture) with a catalyst composition (such as catalyst composition (A) and/or catalyst composition (B)). The catalyst composition can include at least one group 6 metal and at least one group 8-10 metal. The molar ratio of group 6 metal to group 8-10 metal may be from about 10:1 to about 1:10.

A process of the present disclosure can be performed in one or more hydroprocessing reactors (e.g., fixed bed reactor, slurry bed reactor, ebullating bed reactor, or batch high-pressure reactor), in series or in parallel, or in a combination thereof.

Processes may include obtaining, after a hydroprocessing process, a catalyst composition including a Si content of about 1 wt % or less (or 1 wt % or greater if a substantially long time on stream is used), based on the total weight of the catalyst composition, and a liquid product including a total liquid product (TLP) sulfur content of about 5,000 wppm or less. The present disclosure provides hydroprocessing processes to treat a plurality of feeds under wide-ranging reaction conditions. It is within the scope of the present disclosure that more than one type of hydroprocessing catalyst composition can be used in the same reaction vessel/reactor.

The present disclosure provides processes for hydroprocessing a hydrocarbon feedstock which further comprises obtaining a liquid product (e.g., fuel composition product) with a reduced content or removal of sulfur, nitrogen, oxygen, metals, or other contaminations present in the hydrocarbon feedstock, while maintaining a catalyst composition with high catalyst activity for the hydrocarbon feedstock conversion (e.g., a catalyst composition highly resistant to Si poisoning with little to no Si deposited on the catalyst composition).

Prior to introduction to a processing reactor comprising the catalyst composition (e.g., the active sulfided hydroprocessing catalyst composition, activated by sulfidation as described above), the hydrocarbon feedstock may be mixed/combined/blended with a treat gas, thus forming a hydrocarbon feedstock/treat gas mixture, also referred to as a feed. The hydrocarbon feedstock and the treat gas (e.g., hydrogen) may be combined in any order. The hydrocarbon feedstock and the treat gas may be combined prior to introducing the mixture to the catalyst composition of the present disclosure. Alternatively, the hydrocarbon feedstock and the treat gas (e.g., hydrogen) may be introduced into the reactor separately to form a feed mixture. The hydrocarbon feedstock and treat gas can be mixed/combined/blended at hydrocarbon feedstock:treat gas of about 10 scf/b to about 20,000 scf/b, such as from about 100 scf/b to about 5,000 scf/b. In at least one embodiment, the treat gas is hydrogen. The hydrocarbon feedstock and treat gas can be mixed/combined/blended at a temperature of from about 23° C. (73.4° F.) to about 482.2° C. (900° F.). The hydrocarbon feedstock and treat gas can be mixed/combined/blended at a pressure of from about atmospheric pressure to about 5,000 psig. In at least one embodiment, the treat gas is hydrogen. The hydrocarbon feedstock/treat gas (e.g., hydrogen) mixture may pass through a heated guard chamber (e.g., at a temperature within the heated guard chamber of from about 100° C. (212° F.) to about 300° C. (572° F.), such as about 204° C. (400° F.)).

The present disclosure provides processes which can be operable over a range of conditions consistent with the intended objectives in terms of product quality improvement and consistent with any downstream process with which the present disclosure is combined in either a common or sequential reactor assembly, in series or in parallel, or in a combination thereof. Processes of present disclosure can be run at any temperature and/or pressure suitable to obtain the desired liquid product.

The feed rate of the hydrocarbon feedstock can be of from about 0.1 LHSV to about 100 LHSV, such as from about 0.3 LHSV to about 50 LHSV, such as from about 5 LHSV to about 20 LHSV. The hydrocarbon feedstock LHSV may be of from about 0.05 h⁻¹ to about 15 h⁻¹, such as from about 0.1 h⁻¹ to about 12.5 h⁻¹, such as from about 0.5 h⁻¹ to about 10 h⁻¹, such as from about 1 h⁻¹ to about 8 h⁻¹, alternatively from about 5 h⁻¹ to about 25 h⁻¹, such as from about 10 h⁻¹ to about 20 h⁻¹, alternatively from about 5 h⁻¹ to about 10 h⁻¹ Alternatively, the hydrocarbon feedstock LHSV may be of from about 15 h⁻¹ to about 100 h⁻¹, such as from about 25 h⁻¹ to about 75 h⁻¹, such as from about 40 h⁻¹ to about 60 h⁻¹. In at least one embodiment, the feed rate of the hydrocarbon feedstock is from about 0.05 h⁻¹ to about 100 h⁻¹, such as from about 1 h⁻¹ to about 50 h⁻¹, such as from about 5 h⁻¹ to about 25 h⁻¹, such as from about 10 h⁻¹ to about 20 h⁻¹, alternatively from about 5 h⁻¹ to about 10 h⁻¹, alternatively from about 25 h⁻¹ to about 100 h⁻¹.

In at least one embodiment, the present disclosure provides a process for hydroprocessing (e.g., HDS) a hydrocarbon feedstock including a Si content of at least about 1 wppm (e.g., Si content of from about 1 wppm to about 150 wppm), based on the total weight of the hydrocarbon feedstock, by contacting the hydrocarbon feedstock with hydrogen to produce a hydrocarbon feedstock/hydrogen mixture. The process may include introducing the hydrocarbon feedstock/hydrogen mixture (e.g., the feed mixture) with a catalyst composition.

Suitable temperatures and/or pressures for introducing the hydrocarbon feedstock/hydrogen mixture (e.g., the feed mixture) with the catalyst composition include a temperature of from about 200° C. (392° F.) to about 450° C. (842° F.), such as from about 250° C. (482° F.) to about 400° C. (752° F.), such as from about 275° C. (527° F.) to about 350° C. (662° F.), such as about 299° C. (570° F.); and/or at a pressure of from about 50 psig to about 3,000 psig, such as from about 200 psig to about 800 psig, or from about 300 psig to about 500 psig.

In at least one embodiment, hydrogen is present in the hydroprocessing reactor at a pressure of from about 72.51 psig to about 4351.1 psig (about 0.5 MPag to about 30 MPag), such as from about 145 psig to about 3625.9 psig (about 1 MPag to about 25 MPag), such as from about 217.6 psig to about 2900.75 psig (about 1.5 MPag to about 20 MPag).

A hydrogen treat gas can be fed to a reactor, separately or mixed with the hydrocarbon feedstock, at a pressure of from atmospheric pressure to about 5,000 psig, such as from about 100 psig to about 1000 psig, such as from about 200 psig to about 800 psig, such as from about 300 psig to about 500 psig; and/or at a treat gas rate (TGR) of from about 10 scf/b to about 20,000 scf/b, such as from about 200 scf/b to about 15,000 scf/b, such as from about 500 scf/b to about 10,000 scf/b, such as from about 750 scf/b to about 5,000 scf/b, such as from 100 scf/b to about 5,000 scf/b.

In at least one embodiment, the treat gas rate (e.g., hydrogen gas rate) is of from about 200 scf/b to about 15,000 scf/b, such as from about 500 scf/b to about 10,000 scf/b, such as from about 750 scf/b to about 5,000 scf/b.

In a suitable hydroprocessing process, the run time of the reaction, also referred to as the time on stream, can be at least 1 minute or greater, such as about 1 day or greater, such as about 50 days or greater, such as about 100 days or greater, such as about 1 year or greater, such as about 5 years or greater, such as about 10 years or greater.

In at least one embodiment, a hydroprocess includes introducing the hydrocarbon feedstock/treat gas mixture to the catalyst composition at a time on stream of about 100 days or greater, at an LHSV of 15 h⁻¹, such as the time on stream is 5 years or greater, at an LHSV of 15 h⁻¹.

As noted above, depending on the type of hydroprocessing and the reaction conditions, the products of a hydroprocessing process may show improved viscosities, viscosity indices, saturate contents, low temperature properties, volatilities, depolarization, or combinations thereof. It should be understood that hydroprocessing can be practiced in one or more reaction zones, in either countercurrent flow or co-current flow mode. By countercurrent flow mode is meant a process mode in which the feedstream flows in a direction opposite to the flow of hydrogen-containing treat gas. The hydroprocessing reactor can also be operated in any suitable catalyst-bed arrangement mode (e.g., fixed bed, slurry bed, ebullating bed).

Process conditions applicable for the use of the catalyst compositions described herein may vary widely depending on the feedstock to be treated. Thus, as the boiling point of the feedstock increases, the severity of the conditions may also increase. Table 1 serves to illustrate non-limiting example conditions for a range of feedstocks for use in processes of the present disclosure.

TABLE 1

| | Boiling Range | Temperature | Pressure | Space Velocity | H₂ Gas rate |
|---|---|---|---|---|---|
| Feedstock | (° C.) | (° C.) | (bar) | v/v/hour | (scf/b) |
| Naphtha | 25-210 | 100-370 | 10-60 | 0.5-10 | 100-2,000 |
| Diesel (Kerosene/ | 150-350 | 200-400 | 15-150 | 0.2-10 | 500-6,000 |
| Jet Fuels) | | | | | |
| Heavy Gas Oil | 325-475 | 260-430 | 15-170 | 0.3-2 | 1,000-6,000 |
| Lube Oil | 290-550 | 200-450 | 6-210 | 0.2-5 | 100-10,000 |
| Residuum | 10-50% > 500 | 340-450 | 65-1,100 | 0.1-1 | 2,000-10,000 |

In at least one embodiment, the hydroprocessing process is an HDS process which include: introducing a hydrocarbon feedstock (e.g., virgin kerosene) including a Si content of at least about 1 wppm (e.g., Si content of from about 1 wppm to about 150 wppm), based on the total weight of the hydrocarbon feedstock; and introducing the hydrogen to the hydrocarbon feedstock to produce a hydrocarbon feedstock/hydrogen mixture. The process may include introducing the hydrocarbon feedstock/hydrogen mixture (e.g., a feed mixture) to a catalyst composition (e.g., catalyst composition (A) and/or catalyst composition (B)) including at least one group 6 metal and at least one group 8-10 metal, where the ratio of group 6 metal to group 8-10 metal is from about 10:1 to about 1:10. The process can be performed in an HDS reactor (e.g., fixed bed reactor, slurry bed reactor, ebullating bed reactor, batch high-pressure reactor). The process may include obtaining a liquid product and/or a spent catalyst composition including a Si content (Si deposited on the catalyst composition) of about 1 wt % or less, based on the total weight of the catalyst composition, after a substantially long time on stream. Additionally or alternatively, the liquid product may have a TLP sulfur content of about 5,000 wppm or less.

Processes for HDS of a hydrocarbon feedstock may further include obtaining a liquid product a reduced content or removal of sulfur present in the hydrocarbon feedstock (e.g., TLP sulfur content of from 0 wppm to about 5,000 wppm, such as from 0 wppm to about 2,000 wppm, such as from 10 wppm to about 200 wppm). During the HDS process of the hydrocarbon feedstock, high catalyst activity of the catalyst compositions can be maintained. Indeed, in at least one embodiment, the catalyst compositions are highly resistant to Si poisoning with little to no Si deposited on the catalyst compositions, such as the Si content deposited on the catalyst compositions, after a time on stream of about 100 days or greater at high levels of Si in the feed, is of about 1 wt % or less, such as from 0 wt % to about 1 wt %, based on the total weight of the catalyst composition.

In at least one embodiment, the present disclosure provides a process where the catalyst activity of the catalyst compositions is defined by the TLP sulfur content (wppm) of the liquid product during or after the treatment (e.g., hydroprocessing) of the hydrocarbon feedstock, as a function of the TOS of the process (time in which the catalyst composition is present in the hydrocarbon feedstock).

In at least one embodiment, the Si resistance of the catalyst compositions of the present disclosure can be evaluated by measuring the amount of Si (wt %) deposited on the catalyst composition, based on the total weight of the catalyst composition during or after hydroprocessing of the hydrocarbon feedstock, as a function of the TOS of the process (time in which the catalyst composition is present in the hydrocarbon feedstock). The Si content deposited on the catalyst compositions of the present disclosure can be about 1 wt % or less, such as from about 0.0001 wt % to about 1 wt %, such as from about 0.01 wt % to about 0.9 wt %.

Furthermore, high catalyst activity of the catalyst compositions of the present disclosure can be maintained after the Si content of the hydrocarbon feedstock increases via addition of supplementary Si (Si doping of the feedstock), using a silicon-containing compound (e.g., octamethyltrisiloxane).

Furthermore, at high boiling point of the hydrocarbon feedstock (e.g., temperature of from about 37.8° C. (100° F.) to about 900° C. (1,652° F.), such as from about 65.5° C. (150° F.) to about 700° C. (1,292° F.), such as from about 90° C. (194° F.) to about 500° C. (932° F.)), the catalyst composition can maintain its high catalyst activity (e.g., total liquid product sulfur content in the fuel composition product (e.g., liquid product) lower than that of the total liquid product sulfur content in the hydrocarbon feed, at a Si content in the hydrocarbon feedstock of from about 1 wppm to about 150 wppm, at a time on stream of about 50 days to about 150 days, with little to no Si deposited on the catalyst composition).

### Product

In at least one embodiment, a liquid product (e.g., fuel composition product) is formed with a reduced content or removal of sulfur, nitrogen, oxygen, metals, or other contaminations as compared to the hydrocarbon feedstock, while maintaining a catalyst composition with high catalyst activity for the hydrocarbon feedstock conversion (e.g., a catalyst composition highly resistant to Si poisoning with little to no Si deposited on the catalyst composition).

The liquid product of the hydroprocessed hydrocarbon feedstock in the present disclosure can have one or more of: reduced viscosity, reduced density, reduced sulfur and nitrogen contents, reduced Conradson carbon, and reduced asphaltenes content, with an increased cetane index, as compared to the hydrocarbon feedstock.

The contents of sulfur and nitrogen compounds in the hydrocarbon feedstock can be significantly reduced through the hydroprocessing process of the present disclosure. For example, the fuel product composition can have a TLP sulfur content of about 5,000 wppm or less, such as a TLP sulfur content of from about 0.01 wppm to about 5,000 wppm, such as from about 0.01 wppm to about 2,500 wppm, such as from about 0.01 wppm to about 1,000 wppm, such as from about 0.01 wppm to about 500 wppm, such as from about 0.01 wppm to about 200 wppm. Furthermore, the fuel product composition can have a nitrogen content of about 1 wt % or less, based on the total weight of the fuel product composition, such as a nitrogen content of from about 0.001 wt % to about 13 wt %, such as from about 0.001 wt % to about 7.5 wt %, such as from about 0.001 wt % to about 5 wt %, such as from about 0.001 wt % to about 2.5 wt %, such as from about 0.001 wt % to about 1 wt %, such as from about 0.001 wt % to about 0.5 wt %.

The liquid product (e.g., fuel composition product) can be further processed, such as for example, in a residue cracking unit, such as a FCC unit, after removing the lighter fractions (naphtha and diesel). The removed lighter product mixtures of naphtha or diesel may be blended into gasoline, diesel or other value-adding streams in a petroleum refinery.

### EXAMPLES

General conditions Preparation of Catalyst Composition 1.

Catalyst composition 1 was commercially manufactured according to the procedure for the catalyst composition (B) described above. Catalyst composition 1 is also known under the tradename Celestial®.

Virgin kerosene was from ExxonMobil Refinery. Octamethyltrisiloxane, 98% (C₈H₂₄O₂Si₃) was purchased from Sigma-Aldrich. Commercial NiMo catalysts were used.

### Pilot Plant

Hydroprocesses were performed in a pilot plant unit 1 (reactor 1) and a pilot plant unit 2 (reactor 2). The units were configured with a sandbath, liquid pump, and a Brooks mass flow controller. The treat gas (e.g., hydrogen) was mixed with the hydrocarbon feedstock in order to form a feed mixture. The feed mixture was passed through a heated guard chamber (at a heated temperature of 204.4° C. (400° F.)), which contained a pre-sulfided commercial NiMo catalyst) before flowing into the main reactors, to saturate di-olefin. Reactors were plumbed in a down-flow configuration with eight inter-bed thermocouples (4 thermocouples per reactor barrel) to ensure a uniform temperature profile along the catalyst beds. Product samples were collected in closed vessels and stripped of H₂S off-line via bubbled nitrogen.

### Reactor Loading

A total load of 24 cm³ catalyst was loaded into both reactor 1 and reactor 2. The reactor 1 contained the commercial NiMo catalyst. The reactor 2 contained the bulk metal catalyst, Catalyst Composition 1. The reactor 1 was designed to serve as a reference. The compacted bulk density (CBD) was measured on an “as-received” basis and was used to calculate the catalyst volume from the measured catalyst weight.

### Catalyst Activation

Both catalysts (commercial NiMo catalyst and Catalyst Composition 1) were activated exactly the same way, thus following the Catalyst Composition 1 activation procedure: a wet sulfidation technique was employed which used 2.5 wt % DMDS in a virgin (non-cracked) a light gas oil (LGO) feed.

### Feed

The feed used to establish a baseline for steady state operation without added Si was a virgin kerosene feed. A Si doped version of the same virgin kerosene was created to add enhanced levels of Si. To create the Si doped feed, octamethyltrisiloxane (C₈H₂₄O₂Si₃) (purchased from Sigma-Aldrich, 98%) was added in the appropriate proportion to yield an Si dope feed having approximately 100 wppm Si.

Table 2 illustrates the composition and properties of the virgin kerosene feed used for the catalyst activity measurements of the hydroprocessing catalysts and catalysts composition, with a silicon content of 1.2 wppm included in the virgin kerosene feed prior to doping.

TABLE 2
Feed Properties

| | |
|---|---|
| API | 42.82 |
| Feed Sulfur Content, wt % | 0.306 |
| Nitrogen, wppm | 23 |
| Bromine Number, g Br₂/100 g | 1.32 |
| Hydrogen by NMR, wt % | 13.7 |
| Silicon, wppm | 1.2 |

| | Simulated Distillation | |
|---|---|---|
| | Gas Chromatography | Temperature |
| Run | (SIMDIS, %) | (° F.) |
| 1 | 0.5 | 200 |
| 2 | 5 | 291 |
| 3 | 10 | 318 |
| 4 | 20 | 348 |
| 5 | 30 | 373 |
| 6 | 40 | 396 |
| 7 | 50 | 425 |
| 8 | 60 | 450 |
| 9 | 70 | 478 |
| 10 | 80 | 509 |
| 11 | 90 | 551 |
| 12 | 95 | 582 |
| 13 | 99 | 633 |
| 14 | 99.5 | 651 |

### Experimental Description

In order to establish a steady state baseline, a total of 9 mass balances (MBs) with the virgin kerosene (without Si), at 7.5 LHSV, 570° F., 583 psig, and TGR (treat gas rate)=350 scf/b, were used. After establishing a good baseline for performance without Si addition, the Si doped virgin kerosene feed was introduced. 10 mass balances with the Si doped feed were collected. Subsequently, the feed was switched back to the original virgin kerosene (without Si), on which an additional 7 MBs was collected to re-establish the steady state operation without the added Si. Each MB represents one day of unit operation.

The FIGURE is a graph illustrating the catalyst activities for hydroprocessing a hydrocarbon feed using a conventional hydroprocessing catalyst (commercial NiMo catalyst) or Catalyst Composition 1. In particular, the graph is a comparison of the HDS activity of Catalyst Composition 1 and the conventional hydroprocessing NiMo catalyst in a virgin kerosene feed. During time on stream (TOS) 73 days to 82 days, a virgin kerosene feed was processing. Catalyst Composition 1 provided lower total liquid product sulfur (or higher activity) than did the conventional hydroprocessing catalyst. Additionally, TLP sulfur for both Catalyst Composition 1 and the conventional hydroprocessing NiMo catalyst did not change during that period. During TOS 82 days to 92 days, the virgin kerosene, which was spiked with 100 ppm silicon (from the octamethyltrisiloxane, 98%), was processed in order to accelerate the silicon poisoning. As shown in the FIGURE, TLP sulfur increased from about 380 wppm to about 570 wppm for hydroprocesses performed using the conventional hydroprocessing catalyst. In contrast, TLP sulfur remained substantially the same for hydroprocesses performed using Catalyst Composition 1. After TOS of 92 days, the feed was converted back to the virgin kerosene feed. HDS activity for both Catalyst Composition 1 and the conventional hydroprocessing NiMo catalyst remained unchanged during that period. The above results indicated that Catalyst Composition 1 is resistant to silicon poisoning.

### TLP Samples

The Si concentration of each TLP sample collected was determined using ASTM D5185.

### Spent Catalyst Si Concentration

Table 3 illustrates the concentration of the Si deposited on the spent Catalyst Composition 1 and the spent conventional hydroprocessing NiMo catalyst, after collection of the TLP samples. According to the TLP Sulfur results depicted in the FIGURE, Si contamination of the conventional hydroprocessing NiMo catalyst was observed, with a Si content deposited on the catalyst of from 9.6 wt % to 10.4 wt %, based on the total weight of the catalyst. In contrast, Catalyst Composition 1 was resistant to Si contamination, having little to no Si deposited on the Catalyst Composition 1. Indeed, Si content deposited on the Catalyst Composition 1 was observed at 0 wt % (at the top-middle, bottom-middle, and bottom of the reactor) to 0.9 wt % (at the top of the reactor).

TABLE 3

| Catalyst Location | | | |
|---|---|---|---|
| | Top- | Bottom- | |
| Top | Middle | Middle | Bottom |

Reactor 1
(conventional hydroprocessing NiMo catalyst)

| | | | | |
|---|---|---|---|---|
| TLP Sample | 1 | 2 | 3 | 4 |
| Silica Deposited on Catalyst, | 10.4 | 10.3 | 9.6 | 9.6 |
| wt % | | | | |

Reactor 2
(Catalyst Composition 1)

| | | | | |
|---|---|---|---|---|
| TLP Sample | 5 | 5 | 7 | 8 |
| Silica Deposited on Catalyst, | 0.9 | −0.1 | 0 | 0.1 |
| wt % | | | | |

Overall, the present disclosure provides processes for hydroprocessing hydrocarbon feedstocks (having a silicon content of about 1 wppm or greater) by use of silicon-resistant catalyst compositions comprised of at least one group 8-10 metal and at least one group 6 metal. Processes of the present disclosure provide hydroprocessing of hydrocarbon feedstocks having a high silicon content and increased time of stream as compared to conventional hydroprocesses of high silicon feedstocks. Furthermore, processes of the present disclosure provide hydroprocessing of high Si content feeds using catalyst compositions (e.g., bulk catalysts) at high LHSV.

The phrases, unless otherwise specified, “consists essentially” or and “consisting essentially of” do not exclude the presence of other steps, elements, or materials, whether or not, specifically mentioned in this specification, so long as such steps, elements, or materials, do not affect the basic and novel characteristics of the present disclosure, additionally, they do not exclude impurities and variances normally associated with the elements and materials used.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

All documents described herein are incorporated by reference herein, including any priority documents and/or testing procedures to the extent they are not inconsistent with this text. As is apparent from the foregoing general description and the specific embodiments, while forms of the present disclosure have been illustrated and described, various modifications can be made without departing from the spirit and scope of the present disclosure. Accordingly, it is not intended that the present disclosure be limited thereby. Likewise, the term “comprising” is considered synonymous with the term “including.” Likewise whenever a composition, an element or a group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

While the present disclosure has been described with respect to a number of embodiments and examples, those skilled in the art, having benefit of this disclosure, will appreciate that other embodiments can be devised which do not depart from the scope and spirit of the present disclosure.

What is claimed is:

1. A process comprising:
introducing, in a reactor or to the reactor, a hydrocarbon feedstock having a silicon content of at least about 1 wppm, based on the total weight of the hydrocarbon feedstock, to a treat gas to produce a hydrocarbon feedstock/treat gas mixture;
introducing the hydrocarbon feedstock/treat gas mixture to a catalyst composition comprising at least one group 6 metal and at least one group 8-10 metal, wherein the molar ratio of group 6 metal to group 8-10 metal is from about 10:1 to about 1:10; and
obtaining a liquid product having a sulfur content of 5,000 wppm or less, based on the total weight of the liquid product.

2. The process of claim 1, wherein the hydrocarbon feedstock is introduced to the reactor at a feed rate of from about 0.05 h⁻¹ to about 100 h⁻¹.

3. The process of claim 1, wherein the hydrocarbon feedstock has a sulfur content of about 15 wppm or greater, based on the total weight of the hydrocarbon feedstock.

4. The process of claim 1, wherein the hydrocarbon feedstock has a nitrogen content of about 1 wppm or greater, based on the total weight of the hydrocarbon feedstock.

5. The process of claim 4, wherein the hydrocarbon feedstock has a nitrogen content of about 500 wppm to about 5,000 wppm, based on the total weight of the hydrocarbon feedstock.

6. The process of claim 5, wherein the hydrocarbon feedstock has a silicon content of about 2 wppm or greater, based on the total weight of the hydrocarbon feedstock.

7. The process of claim 1, wherein introducing the hydrocarbon feedstock/treat gas mixture to the catalyst composition is performed at a time on stream is 100 days or greater, at an LHSV of 15 h⁻¹.

8. The process of claim 1, wherein the hydrocarbon feedstock is selected from virgin or straight run oil, whole petroleum crude, reduced petroleum crude, biofuel, atmospheric residua, vacuum residua, asphaltene, deasphalted oil, cycle oil, fluid catalytic cracking tower bottom, gas oil, light distillate, middle distillate, heavy distillate, hydrocrackate, hydrotreated oil, dewaxed oil, slack wax, Fischer-Tropsch wax, raffinate, naphtha, or a combination thereof.

9. The process of claim 1, wherein the hydrocarbon feedstock has an end boiling point of from about 37.8° C. (100° F.) to about 900° C. (1,652° F.).

10. The process of claim 1, wherein the hydrocarbon feedstock has a Bromine Number (BN, g Br₂/100 g of the hydrocarbon feedstock) of about 80 or less.

11. The process of claim 1, wherein the hydrocarbon feedstock has a hydrogen content of from about 1 wt % to about 30 wt %.

12. The process of claim 1, wherein the catalyst composition is represented by Formula (I):
(X)_{b}(Mo)_{c}(W)_{d}O_{z} (I)
wherein:
X is a group 8, 9, or 10 metal;
a molar ratio of b:(c+d) is from about 0.5/1 to about 3/1;
a molar ratio of c:d is from about 1/10 to about 10/1; and
z=[2b+6 (c+d)]/2.

13. The process of claim 12, wherein X is a group 8 metal selected from Ni or Co.

14. The process of claims 12, wherein the molar ratio of b:(c+d) of Formula (I) is from about 0.75/1 to about 1.5/1.

15. The process of claim 14, wherein the molar ratio of c:d is from about 2/3 to about 3/2.

16. The process of claim 1, wherein the catalyst composition further comprises a reaction product formed from (i) a first organic compound comprising at least one amine group and (ii) a second organic compound separate from the first organic compound and comprising at least one carboxylic acid group.

17. The process of claim 16, wherein the group 6 metal is selected from Mo, W, or a combination thereof, and wherein the group 8-10 metal is selected from Co, Ni, or a combination thereof.

18. The process of claims 16, wherein the first organic compound comprises at least 10 carbon atoms8, and wherein the second organic compound comprises at least 10 carbon atoms.

19. The process of claims 17, wherein the group 6 metals and group 8-10 metals comprise at least 80 wt % of the catalyst composition.

20. The process of claim 1, wherein the catalyst composition comprises less than 15 wt % carrier or support material, and wherein the catalyst composition further comprises a binder selected from silica, silica-alumina, alumina, titania, zirconia, and mixtures thereof, and wherein the catalyst composition comprises the binder from about 0.01 wt % to about 95 wt % binder, based on the total weight of the catalyst composition,
further comprising sulfiding the catalyst composition prior to introducing the hydrocarbon feedstock to the catalyst composition.

21. The process of claim 1, wherein introducing the hydrocarbon feedstock to the catalyst composition is performed at a temperature from about 200° C. (392° F.) to about 450° C. (842° F.) and a pressure from about 100 psig to about 3,000 psig, and wherein the treat gas is present in the reactor at a pressure of from about 0.5 MPag to about 30 MPag,
further comprising introducing the treat gas to the reactor at a rate of from about 50 scf/b to about 15,000 scf/b.
